(19) United States
(12) Patent Application Publication
(10) Pub. No.: US 2013/0338833 A1
(43) Pub. Date: Dec. 19, 2013

(54) System and Method for Calculating and Reporting Maximum Allowable Operating Pressure

(71) Applicant: Pacific Gas and Electric Company, San Francisco, CA (US)

(72) Inventors: Jose A. Medina, San Ramon, CA (US); Sumeet Singh, Dublin, CA (US); Thomas R. Ford, Oakley, CA (US); Jeffrey D. Allen, Carver, MA (US)

(21) Appl. No.: 13/921,183

(22) Filed: Jun. 18, 2013

Related U.S. Application Data
(60) Provisional application No. 61/661,265, filed on Jun. 18, 2012.

(51) Int. Cl. G05D 16/20

(52) U.S. Cl. CPC G05D 16/20
USPC 700/275

(57) ABSTRACT

Embodiments of the invention provide a pipeline analysis system for analyzing a pipeline dataset to determine compliance with desired maximum allowable pipeline operating pressures. In some embodiments, pipeline component data can correspond to an existing or planned physical pipeline. In some embodiments, the pipeline analysis system can enable revision of the pipeline component data to specify at least one pipeline component having at least one different characteristic than was originally specified in the dataset or specify pipeline components that are in compliance with desired maximum allowable pipeline operating pressures. In some embodiments, the pipeline analysis system comprises a processor, and at least one non-transitory computer-readable storage medium for tangibly storing thereon program logic for execution by the processor. In some embodiments, the program logic comprises logic executed by the processor for receiving and tangibly storing pipeline component data corresponding to an existing or planned physical pipeline.

### BACKGROUND

The industrial age was entirely dependent on newly discovered resources and the means of accessing, storing, and transforming the raw resources into fuel. In 1984, San Francisco lit its gas street lights for the first time, and not long thereafter, other states and other cities were competing discover new uses for, and new sources of gas and later electric power.

An industry was quickly born out of the demand for gas and electricity by factories, businesses, and homes. Massive projects were undertaken by companies that could acquire the adequate capital investment required to construct the pipeline infrastructures required to transport fuel, in the form of gas across towns, cities, and entire states.

Various techniques and philosophies have been developed for inspecting and attempting to determine the health of a pipeline. While many good methods have been put into practice to reduce or eliminate infrastructure failures, a completely fail-proof system has not yet been devised. However, a need is recognized for combining systems and methods in order to process large amounts of data relating to various pipeline components such as, for example, component test data. But test data alone is worth little outside of context. A need exists for systems and methods for processing test data in light of contextual information such as construction and installation dates, construction methods, and historical data in order to create a single system capable of accurately and efficiently calculating maximum pressures for pipelines based on the relevant factors.

### SUMMARY

Some embodiments of the invention provide a pipeline analysis system for analyzing a pipeline dataset to determine compliance with desired maximum allowable pipeline operating pressures. In some embodiments, the pipeline analysis system can revise pipeline component data to specify pipeline components that are in compliance with desired maximum allowable pipeline operating pressures.

In some embodiments, included pipeline component data can correspond to an existing or planned physical pipeline. In some embodiments, the pipeline analysis system can enable revision of the pipeline component data to specify at least one pipeline component having at least one different characteristic than was originally specified in the dataset. In some embodiments, the revised dataset can be analyzed to determine the maximum allowable pipeline operating pressure for the existing or planned physical pipeline.

In some embodiments, the pipeline analysis system comprises a processor, and a first non-transitory computer-readable storage medium for tangibly storing thereon program logic for execution by the processor. In some embodiments, the program logic comprises logic executed by the processor for receiving and tangibly storing on a second non-transitory computer-readable storage medium a dataset including pipeline component data corresponding to an existing or planned physical pipeline. Some embodiments include logic executed by the processor for analyzing the dataset to determine compliance with desired maximum allowable pipeline operating pressures. Some embodiments also include logic executed by the processor for enabling revision of the pipeline component data to specify pipeline components that are in compliance with desired maximum allowable pipeline operating pressures, and logic executed by the processor for providing an exception report listing non-compliant pipeline components.

In some embodiments, the pipeline component data includes data corresponding to pipe segments, pipe fittings and pipe valves. Some embodiments include batch processing techniques for analyzing the data set.

In some embodiments, the dataset contains pipeline component data for an entire pipeline.

In some embodiments, the pipeline analysis system analyzes the dataset at least in part by comparing the pipeline component data to an industry standard pipeline database stored on a third non-transitory computer-readable medium.

### DESCRIPTION OF THE DRAWINGS

FIG. 1 is a flow chart showing a determination of whether an identified feature is a pipe or a pipe component according to one embodiment of the invention.

FIG. 2 is a flow chart showing a specified minimum yield strength (SMYS) test for zero according to one embodiment of the invention.

FIG. 3 is a flow chart showing a decision point relating to specified minimum yield strength (SMYS) indicating an assumption was used or data was obtained by a field investigation according to one embodiment of the invention.

FIG. 4 is a flow chart showing the OD—maximum allowable operating pressure (MAOP) Report according to one embodiment of the invention.

FIG. 5 is a flow chart showing a method for OD calculation according to one embodiment of the invention.

FIG. 6 is a flow chart showing an OD calculation and assignment according to one embodiment of the invention.

FIG. 7 is a flow chart showing an OD 2 assignment according to one embodiment of the invention.

FIGS. 8A-8B are a flow chart showing methods for LS factor assignment according to one embodiment of the invention.

FIG. 9 is a flow chart showing the valid test for >30% SMYS? 1 class out? according to one embodiment of the invention.

FIGS. 10A-10B are a flow chart showing the strength test factor relative to converted date for table search according to one embodiment of the invention.

FIG. 11 is a flow chart showing methods related to the supported feature MAOP according to one embodiment of the invention.

FIGS. 12A-12B are a flow chart showing methods for the STPR supported MAOP according to one embodiment of the invention.

FIGS. 13A-13B are a flow chart showing the MAOP according to one embodiment of the invention.

FIG. 14 is a flow chart showing the code compliant allowable pressure according to one embodiment of the invention.

FIG. 15 is a flow chart showing the % SMYS (specified minimum yield strength) @ MAOP of record when a rated fitting is not used according to one embodiment of the invention.

FIG. 16 is a flow chart showing the % SMYS at the supported feature MAOP according to one embodiment of the invention.

FIG. 17 is a flow chart showing the % SMYS @ MAOP of record according to one embodiment of the invention.

FIG. 18 is a flow chart showing the limited MAOP according to one embodiment of the invention.

FIG. 19 is a flow chart showing the design factor according to one embodiment of the invention.

FIG. 20 is a flow chart showing the WT—MAOP is equal to WT @ minimum DP location according to one embodiment of the invention.

FIG. 21 is a flow chart showing the WT footnote—MAOP report indicating an assumption was used or data was obtained by field investigation according to one embodiment of the invention.

FIG. 22 is a flow chart showing the fitting rating—MAOP report is N/A if N/A is an unknown according to one embodiment of the invention.

FIG. 23 is a flow chart showing the footnote fitting rating—MAOP report indicating an assumption was used or data was obtained by field investigation according to one embodiment of the invention.

FIGS. 24A-24B are a flow chart showing the feature MAOP according to one embodiment of the invention.

FIG. 25 is a flow chart showing the joint efficiency factor—MAOP report for CAP equals N/A, otherwise equals LS Factor according to one embodiment of the invention.

FIG. 26 is a flow chart showing the test pressure—the MAOP report equals N/A if no test according to one embodiment of the invention.

FIG. 27 is a flow chart showing the footnote MAOP [R]—the maximum MAOP report equals B if A pressure reduction from MAOP per record according to one embodiment of the invention.

FIG. 28 is a flow chart showing the MAOP per design—the MAOP report is either one class out, fitting MAOP, or minimum of DP @ 1 or 2 according to one embodiment of the invention.

FIG. 29 is a flow chart showing the test year equaling MAOP report equals test one? according to one embodiment of the invention.

FIG. 30 is a flow chart showing the % SMYS Per R—MAOP report equals minimum DP Location @ MAOP per recon according to one embodiment of the invention.

FIG. 31 is a flow chart showing the footnote MAOP [D]—MAOP report equals A when MAOP per design is one class out according to one embodiment of the invention.

FIGS. 32A-32B are a flow chart showing the operating in class according to one embodiment of the invention.

FIGS. 33A-33B are a flow chart showing the MAOP limit factor according to one embodiment of the invention.

FIG. 34 is a flow chart showing the calculated DP @ 1 according to one embodiment of the invention.

FIG. 35 is a flow chart showing the calculated DP @ 2 according to one embodiment of the invention.

FIG. 36 is a flow chart showing the minimum DP location according to one embodiment of the invention.

FIG. 37 is a flow chart showing the DP according to one embodiment of the invention.

FIG. 38 is a flow chart showing the seam type footnote—MAOP report indicating an assumption was used or data was obtained by field investigation according to one embodiment of the invention.

FIG. 39 is a flow chart showing the Fitting MAOP from a lookup table with WOG and ANSI values according to one embodiment of the invention.

FIGS. 40A-40B are a flow chart showing the seam type according to one embodiment of the invention.

FIG. 41 is a schematic diagram showing the structure for the analysis template and MAOP report including the PFL body with the pipeline features, and FVE columns which produces the MAOP report according to one embodiment of the invention.

FIG. 42 is an example of a MAOP report according to one embodiment of the invention.

FIG. 43 is a flow chart showing the process for the MAOP data validation project according to one embodiment of the invention.

FIGS. 44A-44C is a spreadsheet diagram showing the feature specifications for the FVE columns according to one embodiment of the invention.

FIGS. 45A-45B are a spreadsheet diagram showing the structure for the MAOP report according to one embodiment of the invention.

FIG. 46 is a spreadsheet diagram showing the calculations used in determining a design pressure (DP) for the MAOP report according to one embodiment of the invention.

FIG. 47 is a spreadsheet diagram showing the MAOP per test for the MAOP report Calculations according to one embodiment of the invention.

FIG. 48 is a spreadsheet diagram showing another view of the MAOP per test for the MAOP report calculations according to one embodiment of the invention.

FIG. 49 is a spreadsheet diagram showing the Assumptions for the MAOP report footnote guide according to one embodiment of the invention.

FIG. 50 is a spreadsheet diagram showing the 611 calculations for the MAOP report footnote guide according to one embodiment of the invention.

FIG. 51 is a spreadsheet diagram showing reduced pressure operation compared to recon for the MAOP report footnote guide according to one embodiment of the invention.

FIG. 52 is a flow chart showing the MAOP report upload and centralized calculator for Intrepid™ software according to one embodiment of the invention.

FIG. 53 is a flow chart showing the centralized calculator for Intrepid™ according to one embodiment of the invention.

FIG. 54 depicts a system architecture and MAOP report methods including batch execution across all the pipeline segments in the PODS database in accordance with some embodiments of the invention.

FIG. 55 shows one example of a software front-end interface for selecting MAOP reports including batch processing MAOP reports in accordance with some embodiments of the invention.

FIG. 56 illustrates a pipeline route with associated pipeline segments and associated data tables in accordance with one embodiment of the invention.

FIG. 57 illustrates methods for MAOP calculations using one embodiment of the system architecture of FIG. 54 including batch processing of compliance reports in accordance with some embodiments of the invention.

FIG. 58 illustrates methods to determine and set override values based on whether MAOP calculator values are null or unknown in accordance with some embodiments of the invention.

FIG. 59 illustrates methods to input one or more pipeline designs using a computer aided design software package 5910 for use in MAOP calculations in accordance with one embodiment of the invention.

FIG. 60 shows one example of system architecture capable of implementation of at least one of the methods or reports as shown in FIGS. 1-53 according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

Moreover, the figures disclosed and described herein represent high-level visualizations of decision points and actions that may be incorporated for calculating and compiling the disclosed MAOP report. Those of ordinary skill in the art will appreciate that each figure is presented for explanation only and does not include each and every decision, function, and feature that may be implemented. Likewise, the figures and related discussions are not intended to imply that each and every illustrated decision, function, and feature is required or even optimal to achieve the disclosed desired results.

A significant portion of the specification's figures comprise functional blocks, which are intended to sufficiently illustrate the computerized instructions and logic employed by a computing system for calculating and compiling the disclosed MAOP report.

In general, the disclosed system and method assists engineers and operators in efficiently and accurately identifying infrastructure weaknesses so that the weaknesses can be addressed in advance of encountering a negative event. In the context of fuel pipelines, for example, the disclosed calculator helps engineers to identify and/or predict potential weaknesses in the high-pressure infrastructure that may eventually lead to a rupture, for example, that may be injurious or monetarily and environmentally costly. Such weaknesses may occur as a result of normal aging and environmental wear on the many components that are used to construct and maintain pressurized pipelines, which are often used to transport caustic and/or hazardous fuels across geographic spans.

The industry has produced several methods and systems to minimize environmental damage and long-term health effects.

Many prior art methods for reducing an entity's risk exposure traditionally comprise an informal implementation of specific procedures and practices that are passed down through an organization over time. More recent efforts have led to less subjective computer programs that accept inputs and perform calculations to highlight areas of potential risk exposure. However, such systems typically base their calculations on non-specific data. In other words, a given size of a sleeve may be assigned a particular value regardless of manufacturer or construction material.

More significantly, many prior art computing systems do not utilize historical data in a meaningful way, such that it serves as a foundation for present day data. For example, a particular sleeve may have an associated failure rate as determined by manufacturer testing. However, in practical use, the same sleeve may have a significantly higher failure rate in an area of high humidity, for example, despite other environmental conditions that were replicated during testing. Moreover, by simply using test data for each component within a calculation of a infrastructure as a whole, the overall calculation includes a culmination of test data for each component that is a part of the infrastructure.

Contrary to such prior art calculation systems and methods, the same embodiments, the present system utilizes historical data, which reflects real-world results culminating from a specific combination of various components under any number of environmental variables. Moreover, slight variation in manufacturing conditions can affect the reliability of a component (e.g., the maximum pressure capacity of a pipe). These slight variances alone may not be significant enough to create a discernable or detectable result. However, a combination of historical data, which includes sufficient details regarding the very specific components used with present day test data, for example, can provide a more accurate and reliable calculation, leading to a more proactive approach to maintaining critical infrastructure components.

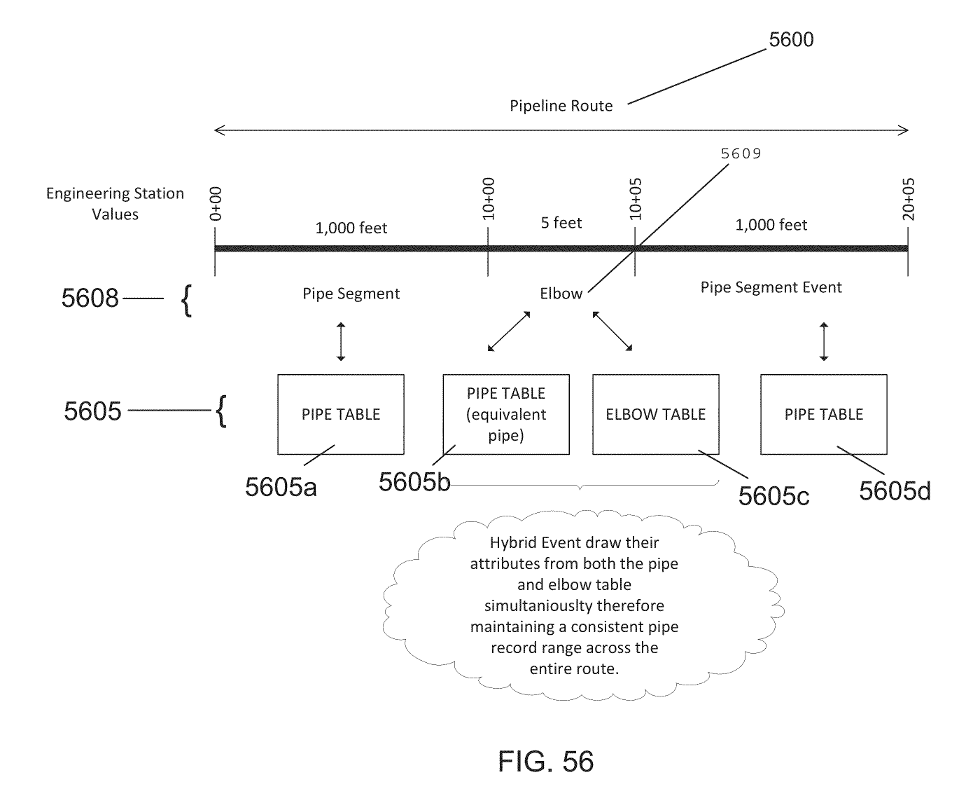

Some embodiments of the disclosed system and method include an ability to utilize historical, pre-existing data to produce more precise calculations, resulting in more true-to-life outcomes. For example, historical information may include the type of sleeves to link pipe segments (for example, pipe segments 5608 shown in FIG. 56) in the construction of a pipeline, long before the present system was developed. Moreover, the system may accept data pertaining to methodologies used in various aspects of construction. For example, what was the commonly accepted cure time for epoxy cement before a first pressure test was allowed to be performed? The inclusion of historical data can have an immediate affect on the calculation outcomes beyond the addition of present day variables.

In some embodiments, the disclosed system and method provides a computerized tool that automates large and often complex tasks. Those tasks include identifying potential problems before the problems occur by determining the age of a combination of infrastructure components and using practical experience with historical knowledge regarding the reliability and lifespan of the various infrastructure components to assist in infrastructure maintenance decisioning processes. In one embodiment, the disclosed system may be utilized for estimating and predicting failure probabilities in a pipeline by removing subjectivity from the calculation process, in favor of objective data resulting from knowledge obtained over a period of time.

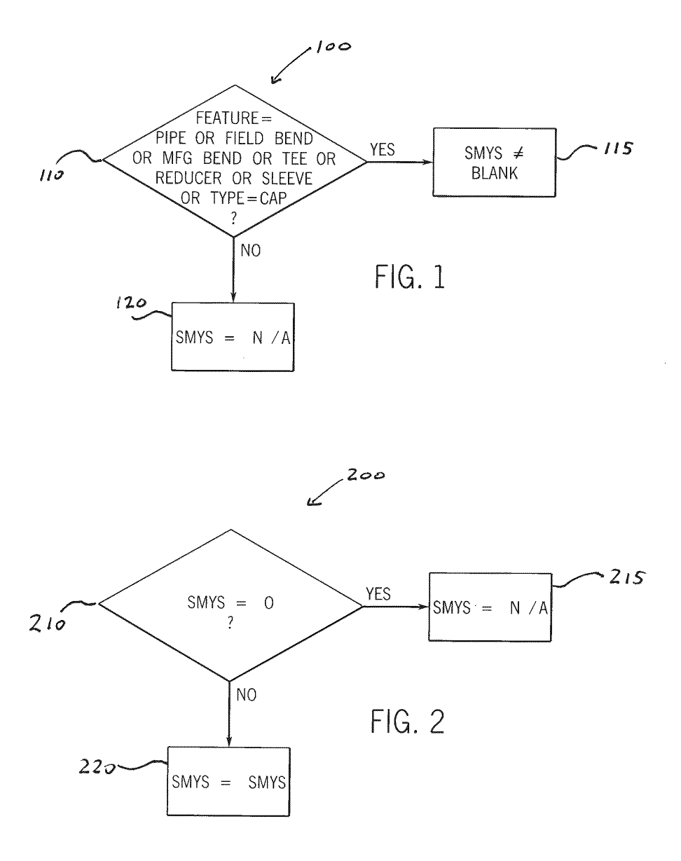

Some embodiments include various systems and methods for calculating and reporting a maximum allowable operating pressure (hereinafter referred to as “MOAP”) of at least one component of a natural gas pipeline. In some embodiments, the MOAP can be calculated using at least one specified minimum yield strength (hereinafter referred to as “SMYS”) of at least one component. In some embodiments, the MOAP can be calculated using at least one of the flowcharts 100, 200, 300, 400, 500, 600, 700, 800, 900, 1000, 1100, 1200, 1300, 1500, 1600, 1650, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000 as described in FIGS. 1-40B.

Some embodiments can include one or more variables of an operating pressure (hereinafter referred to as “OP”).

Some embodiments of the invention can include one or more variables of a pipe outer diameter. In some embodiments, the OD can be a major or primary pipe outer diameter (which can be referred to as “OD 1”), and in some other embodiments, the OD can be a secondary outer diameter (which can be referred to as “OD 2”).

Some embodiments of the invention can include one or more variables of a design pressure (hereinafter referred to as “DP”).

Some embodiments of the invention can include one or more variables of a wall thickness (hereinafter referred to as “WT”). In some embodiments, a component may comprise a first wall thickness and a second wall thickness (hereinafter referred to as “WT1” and WT2″ respectively).

Some embodiments of the invention can include one or more variables of field verification engineers (hereinafter referred to as “FVE”) and/or one or more actions performed or to be performed by FVE.

In some embodiments, any one variable of the system and method may be assigned as non-applicable (hereinafter referred to as “N/A”).

Some embodiments of the invention can include one or more variables of a long seam factor (hereinafter referred to as “LS factor”).

Some embodiments include one or more components manufactured by A. O. Smith Corporation, P.O. Box 245008, Milwaukee, Wis. 53224, USA (hereinafter referred to as “AO Smith”).

Some embodiments of the invention can include at least one system or method for exchanging data with a Pipeline Open Data Standard database and model (hereinafter referred to as “PODS”).

Some embodiments of the invention can include at least one calculation using Barlow's formula (hereinafter referred to as “Barlows”).

FIG. 1 is a flow chart 100 showing a determination 110 of whether an identified feature for use in a calculation is a pipe or a pipe component (e.g., a field bend, manufacturers bend, tee, reducer, sleeve or cap type) according to one embodiment of the invention. According to this embodiment, the determination 110 regarding a particular feature results in either a true or a false result. In the negative case 120, an SMYS value is indicative of being not applicable. In the positive case 115, an SMYS value is maintained to identify the feature.

FIG. 2 is a flow chart 200 showing an SMYS test for zero according to one embodiment of the invention. In this embodiment, a decision 210 is performed to first determine whether the SMYS value is equal to zero. If SMYS does equal zero, then a variable representing SMYS is assigned an “NA” value (215); otherwise, the existing SMYS value is maintained (220).

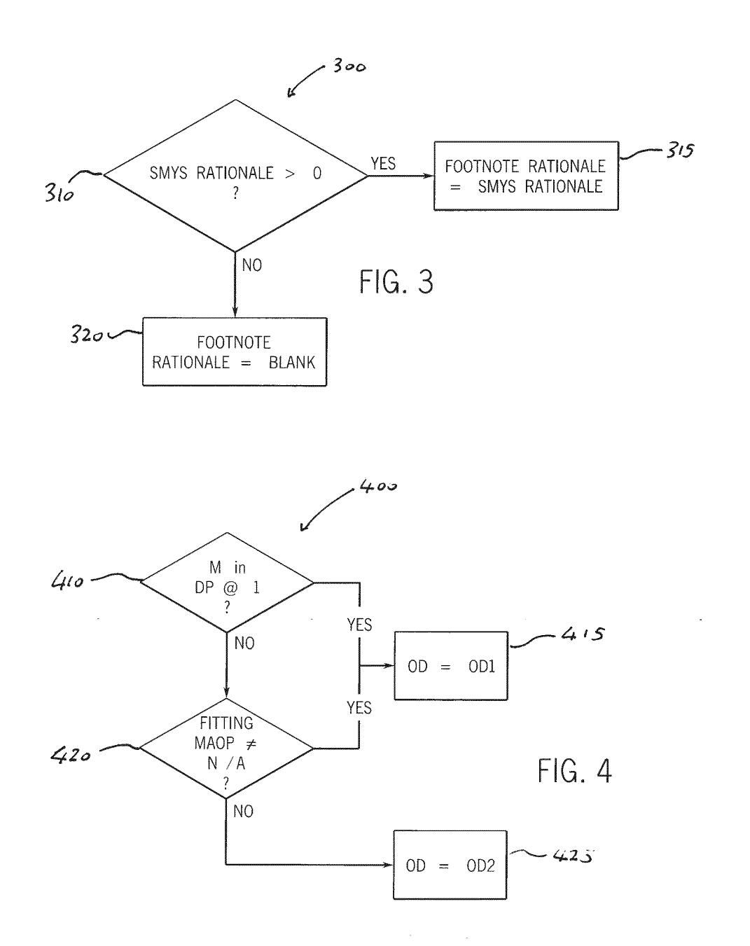

FIG. 3 is a flow chart 300 showing a decision point 310 relating to SMYS according to one embodiment of the invention. In accordance with this embodiment, a footnote rationale value equals the SMYS rationale when the SMYS rationale value is greater than zero (315). If the SMYS rationale value is not greater than zero, then the footnote rationale value is blank or empty (320).

FIG. 4 is a flow chart 400 showing the OD—MAOP report according to one embodiment of the invention. In accordance with this embodiment, FIG. 4 illustrates two decision points 410, 420. A first decision point 410 is for determining whether the minimum DP value is at “1”. If it is at one, then the OD value equals the OD 1 value (415). Otherwise, a second decision point 420 is executed to determine whether a fitting MAOP value does not equal “N/A”. If the fitting MAOP is “N/A”, then OD equals OD 2 (425); otherwise, OD equals OD 1 (415).

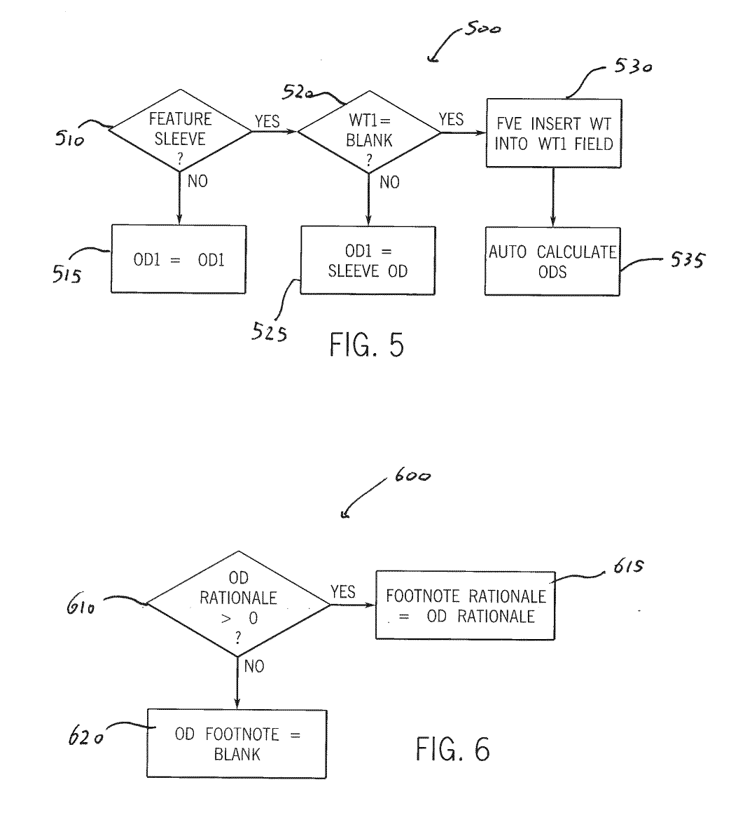

FIG. 5 is a flow chart 500 showing a method for OD calculation according to one embodiment of the invention. In accordance with this embodiment, a decision point 510 determines whether a component is a sleeve feature. If the component is a sleeve feature, then a next determination 520 is made as to whether a WT1 field is blank. If the WT1 field is blank, then FVE insert WT into the WT1 field (530) and auto calculate the OD of the sleeve (535). If the WT1 field is not blank, then OD 1 equals the sleeve OD (525). If the component is not a sleeve feature, then OD 1 is made equal to OD 1.

FIG. 6 is a flow chart 600 showing an OD calculation and assignment according to one embodiment of the invention. If a determination 610 is made that an OD rationale is greater than zero, then the footnote rationale equals the OD rationale (615). Otherwise, the OD footnote is left blank (620).

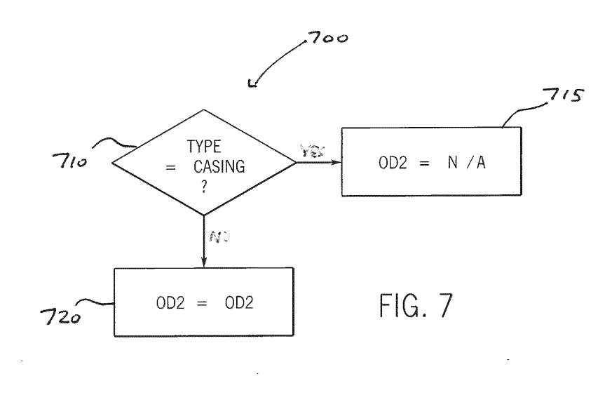

FIG. 7 is a flow chart 700 showing an OD 2 assignment according to one embodiment of the invention. According to this embodiment, a determination 710 is made as to whether the feature type is a casing. If the type is a casing, then the OD 2 field value is set to N/A (715). If the type is not a Casting, then the OD 2 field value retains the present value of OD 2 (720).

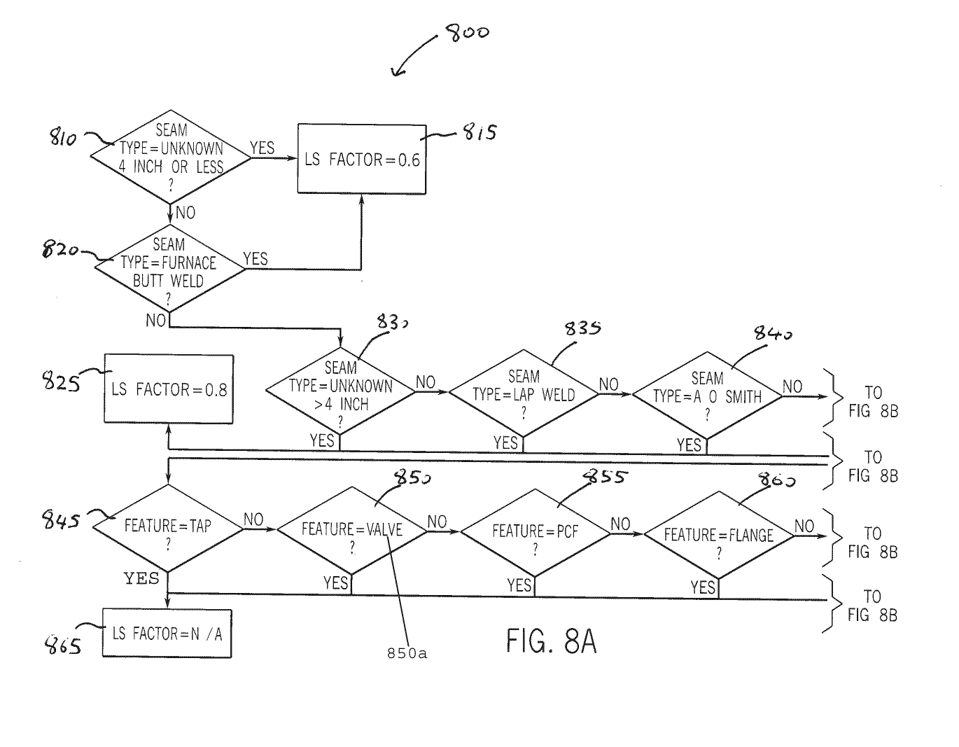

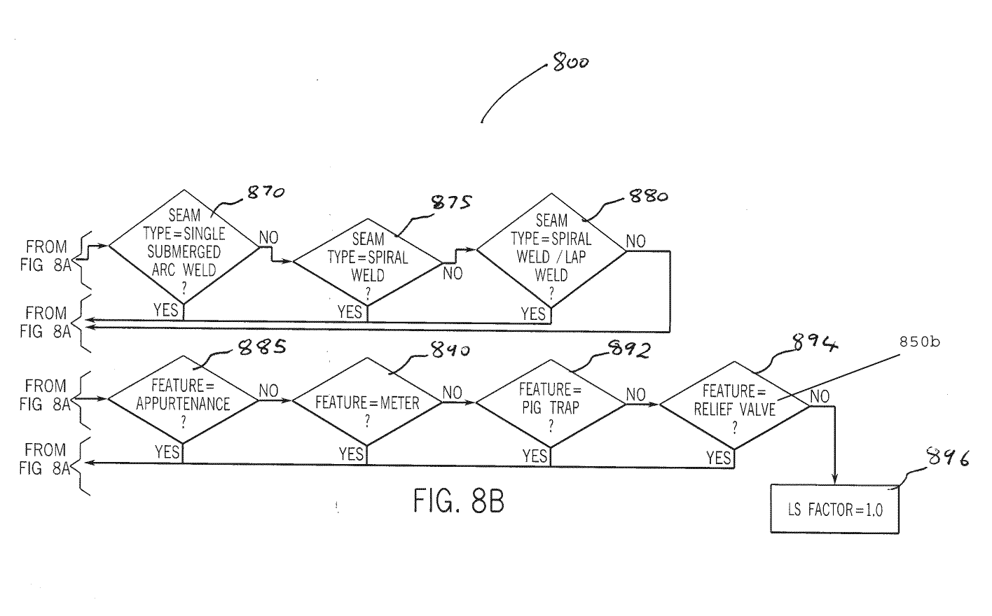

FIGS. 8A-8B are a flow chart 800 showing methods for LS factor assignment according to one embodiment of the invention. In one embodiment, a series of decision points 810, 820, 830, 835, 840, 845, 850, 855, 860, 870, 875, 880, 885, 890, 892, 894 can be used to identify a seam type and a feature in order to set the LS factor value. In some embodiments a determination 810 is used to ascertain if the seam type is unknown and four inches or less. If true, then the LS factor is assigned as 0.6. Otherwise, a determination 820 is made as to whether or not the seam type is a butt weld. If true, then the LS factor is assigned 0.6. If false, then a determination 830 is performed to determine if the seam type is unknown and greater than four inches. If true, then the LS factor is assigned as 0.8 (825). If false, then a determination 835 is performed to determine if the seam type is a lap weld. If true, then the LS factor is assigned as 0.8 (825). If false, then a determination 840 is performed to determine if the seam type is AO Smith. If true, then the LS factor is assigned as 0.8 (825). If false, then a determination 870 is made as to whether the seam type is a single submerged arc weld. If true, then the LS factor is assigned as 0.8 (825). If false, then a determination 875 is made as to whether the seam is a spiral weld. If true, then the LS factor is assigned as 0.8 (825). If false, then a determination 880 is made as to whether or not the seam is a spiral type weld or a lap type weld. If true, then the LS factor is assigned as 0.8 (825). If false, then a determination 845 is made as to whether or not the feature is a tap. If true, then the LS factor is assigned as N/A (865). If false, then a determination 850 can ascertain if the feature is a valve 850a. If true, then the LS factor is assigned as N/A (865). If false, then a determination 855 can ascertain of the feature is a PCF type fitting. If true, then the LS factor is assigned as N/A (865). If false, then a determination 860 can ascertain of the feature is a flange type fitting. If true, then the LS factor is assigned as N/A (865). If false, then a determination 885 can ascertain of the feature is an appurtenance. If true, then the LS factor is assigned as N/A (865). If false, then a determination 890 can ascertain of the feature is a meter. If true, then the LS factor is assigned as N/A (865). If false, then a determination 892 can ascertain of the feature is a pig trap. If true, then the LS factor is assigned as N/A (865). If false, then a determination 894 can ascertain of the feature is a relief valve 850b. If true, then the LS factor is assigned as N/A (865). If false, then the LS factor equals 1.0.

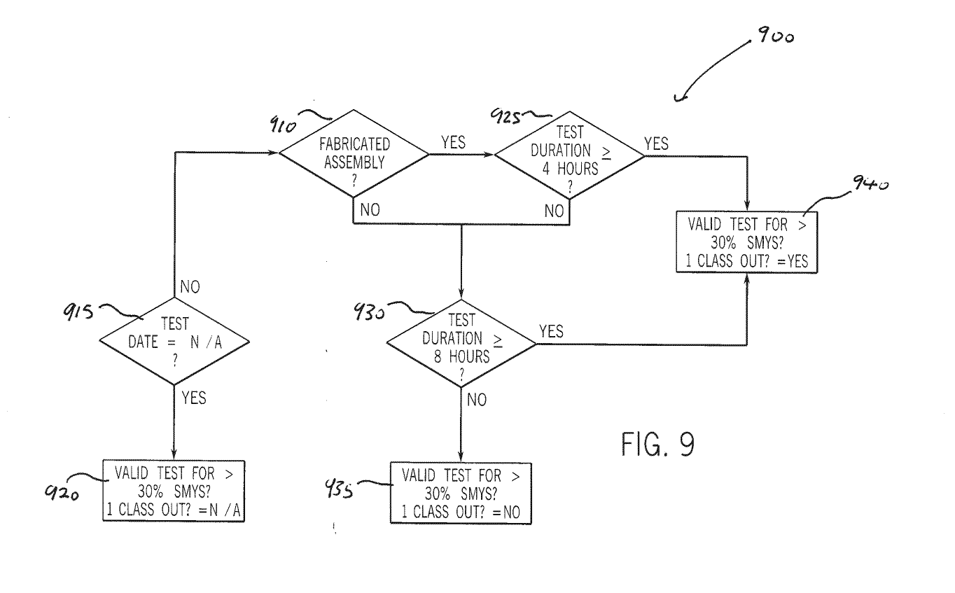

FIG. 9 is a flow chart 900 showing the Valid Test for >30% SMYS? 1 Class Out? in accordance with one embodiment of the invention. In accordance with this embodiment, several decision points 910, 925, 915, 930 are included into the process for test date (915), fabricated assembly (910), and test duration (925, 930) in order to set a valid test value to “Yes”. As shown, in some embodiments, if a determination 915 to ascertain if the test date is N/A is true, then the valid test for greater than 30% SMYS? 1 class out? is N/A (920). If false, then a determination 910 ascertains whether or not the component is a fabricated assembly. If true, then a determination 925 can ascertain if the test duration is greater than or equal to four hours. If yes, then a valid test for greater than 30% SMYS? 1 class out? is equal to “YES” (940). Further, if the determination 910 is negative, then a determination 930 can ascertain if the test duration is greater than or equal to 8 hours, and if true, then a valid test for greater than 30% SMYS? 1 class out? is equal to “YES” (940). If the determination 930 is false, then a valid test for greater than 30% SMYS? 1 class out? is equal to “NO”.

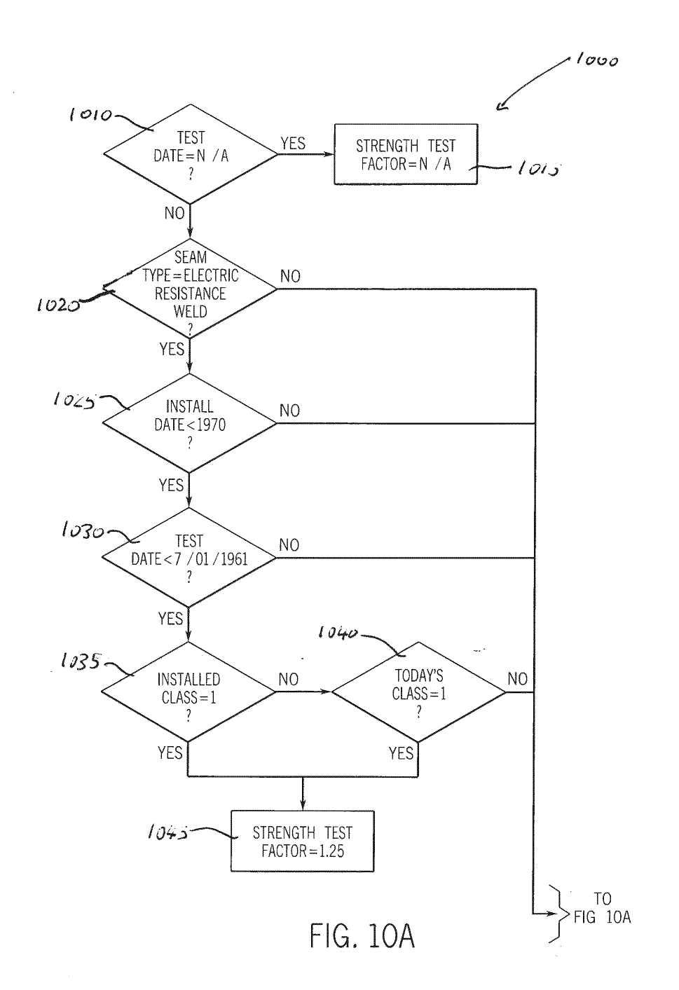

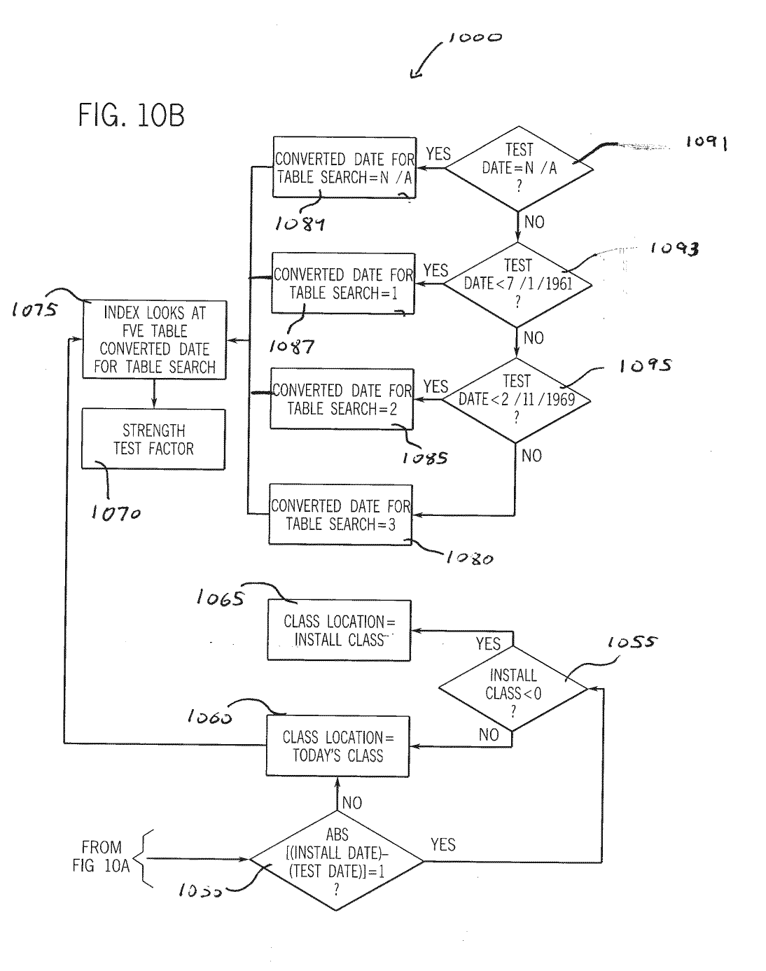

FIGS. 10A-10B are a flow chart 1000 to determine the strength test factor for a test by indexing the test date by class location. Potential low frequency ERW pipe is also evaluated according to some embodiments of the invention. As shown, the chart 1000 can include numerous determinations including 1010, 1020, 1025, 1030, 1035, 1040, 1091, 1093, 1095, 1055 and 1050. For example, in some embodiments, through a determination 1010, if a test date is N/A, then the strength test factor is N/A (1015). If the test date is applicable, then a determination 1020 can ascertain if the seam type is an electric resistance weld. If yes, then a determination 1025 can ascertain if the install date was less than 1970. If yes, then a determination 1030 can determine of the test date was less than Jul. 1, 1961. If yes, then a determination can ascertain if the installed class is equal to 1. If yes, then the strength test factor is equal to 1.25. If determination 1035 is no, then a determination 1040 can ascertain if today's class is 1, and if yes, then the strength test factor is equal to 1.25. In some embodiments, if any one the determinations 1020, 1025, 1030, 1035, or 1040 is negative, then a determination 1050 can ascertain if ABS [(Install Date)−(Test Date)] equals 1. In a positive outcome of determination 1050, a determination 1055 can ascertain if an install class is less than zero. In a positive outcome, the class location equals the install class. In some embodiments, a negative outcome for determinations 1050, 1055 leads to the class location equating to today's class (1060), index looks at FVE table converted date for the table search (1075), and strength test factor (1070). Further, a determination 1091 can ascertain if the test date is N/A, and if yes, the converted date for table search is N/A, and index looks at FVE table converted date for the table search (1075), and strength test factor (1070). If determination 1091 is false, then a determination 1093 can ascertain if test date is less than Jul. 1, 1961, and if yes, converted date for table search equals 1, and index looks at FVE table converted date for the table search (1075), and strength test factor (1070). If determination 1093 is false, then a determination 1095 can ascertain if the test date is less than Feb. 11, 1969, and if yes, converted date for table search equals 2, and index looks at FVE table converted date for the table search (1075), and strength test factor (1070). If no, then converted date for table search equals 3, and index looks at FVE table converted date for the table search (1075), and strength test factor (1070).

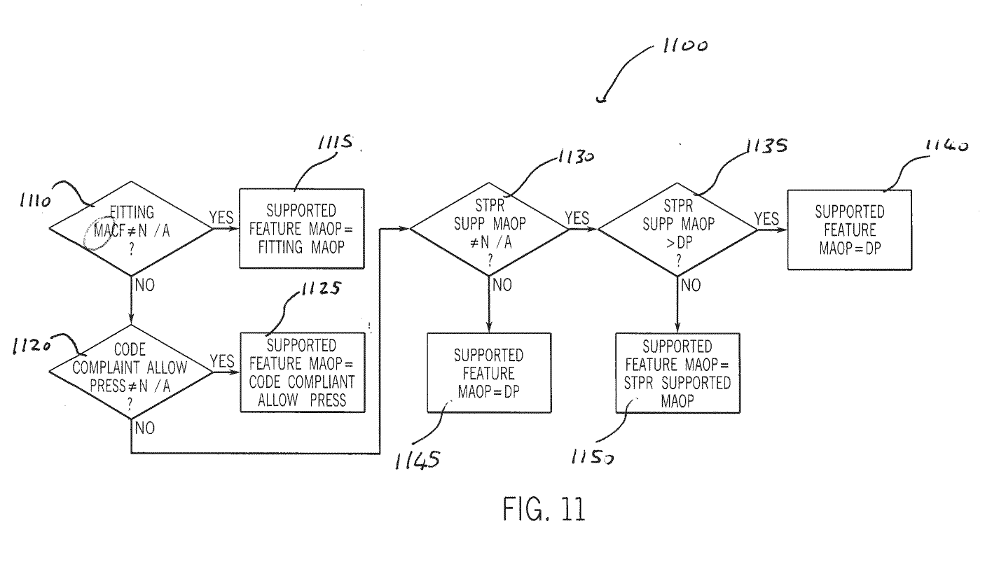

FIG. 11 is a flow chart 1100 showing methods related to the supported feature MAOP according to one embodiment of the invention. As shown, the method can include various determinations 1110, 1120, 1130, 1135. In accordance with this embodiment, determination 1110 can ascertain if a fitting MACF does not equal N/A. If the outcome is positive, a supported feature MAOP is equal to the fitting MAOP (1115). If the determination 1110 is negative, a determination 1120 can assess if code complaint allow press is not equal to N/A. For a positive outcome, supported feature MAOP equals code compliant allow press (1125). For a negative outcome, a determination 1130 can assess if STPR SUPP MAOP is not equal to N/A. For a negative outcome, supported feature MAOP equals DP. For a positive outcome, a determination 1135 can assess if STPR SUPP MAOP is greater than DP. For a negative outcome, supported feature MAOP equals STPR supported MAOP (1150). However, for a positive outcome, supported feature MAOP equals DP.

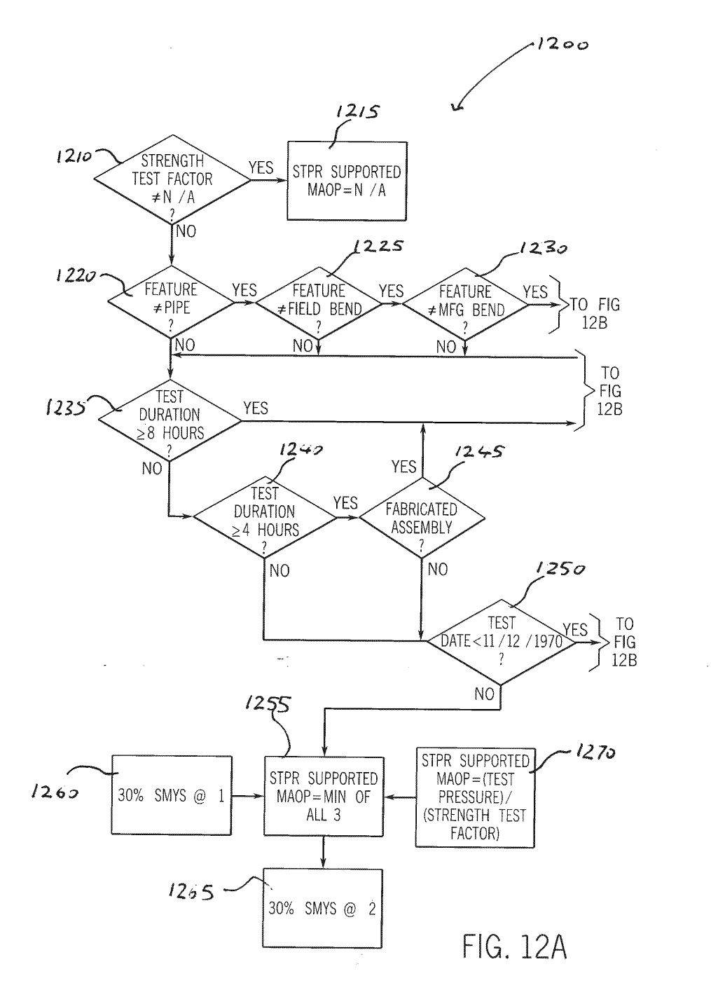

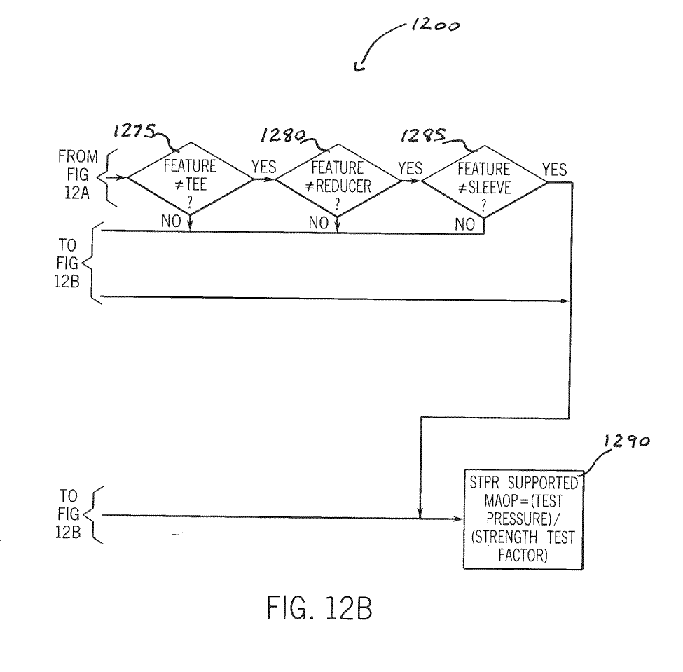

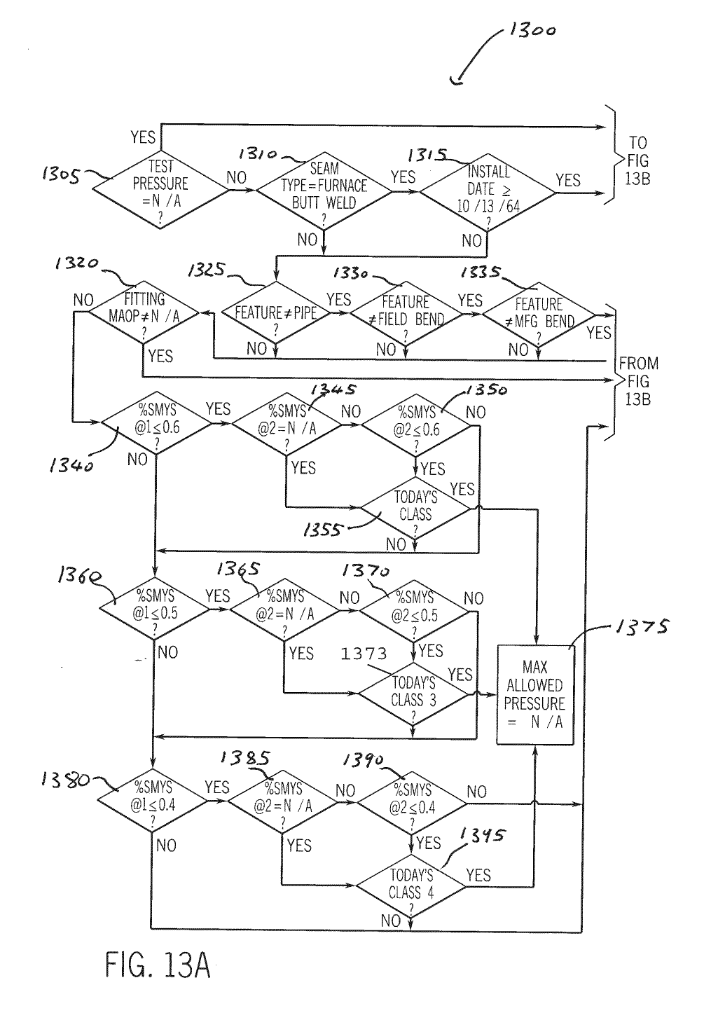

FIGS. 12A-12B are a flow chart 1200 showing methods for STPR supported MAOP according to one embodiment of the invention. As shown, some embodiments include determinations 1210, 1220, 1225, 1230, 1235, 1240, 1245, 1250, 1275, 1280, and 1285. In some embodiments, if a strength test factor is not equal to N/A (1210), then STPR supported MAOP equals N/A (1215). Conversely, if a strength test factor is equal N/A (1210), then a determination 1220 can ascertain if feature does not equal pipe. If the answer is positive, then determination 1225 can ascertain if feature doe not equal field bend. If the answer is positive, then determination 1230 can ascertain if feature does not equal manufacturer bend. If the answer is positive, then determination 1275 can ascertain if feature does not equal tee. If the answer is positive, then determination 1280 can ascertain if feature does not equal reducer. If the answer is positive, then determination 1275 can ascertain if feature does not equal sleeve. If determinations 1220, 1225, 1230, 1275, 1280, or 1285 or negative, then a determination 1235 can ascertain if test duration is greater than or equal to 8 hours. In some embodiments, if either of determinations 1235 or 1285 are positive, then STR supported MAOP is equal to test pressure divided by strength test factor (1290). In some embodiments, if determination 1235 is negative, the a determination 1240 can ascertain if test duration is greater than or equal to 4 hours. If the answer is positive, then a determination 1245 can test for fabricated assembly. If the answer is positive, then STR supported MAOP is equal to test pressure divided by strength test factor (1290). If either of determinations 1240, 1245 are negative, then a determination 1250 can ascertain if test date is less than Nov. 12, 1970. If the answer is positive, then STR supported MAOP is equal to test pressure divided by strength test factor (1290). If the answer is negative, then, STPR supported MAOP equals min of all three (1255), 30% SMYS is at 1 (1260), STPR supported MAOP equals test pressure divided by strength test factor (1270) and 30% SMYS is at 2 (1265).

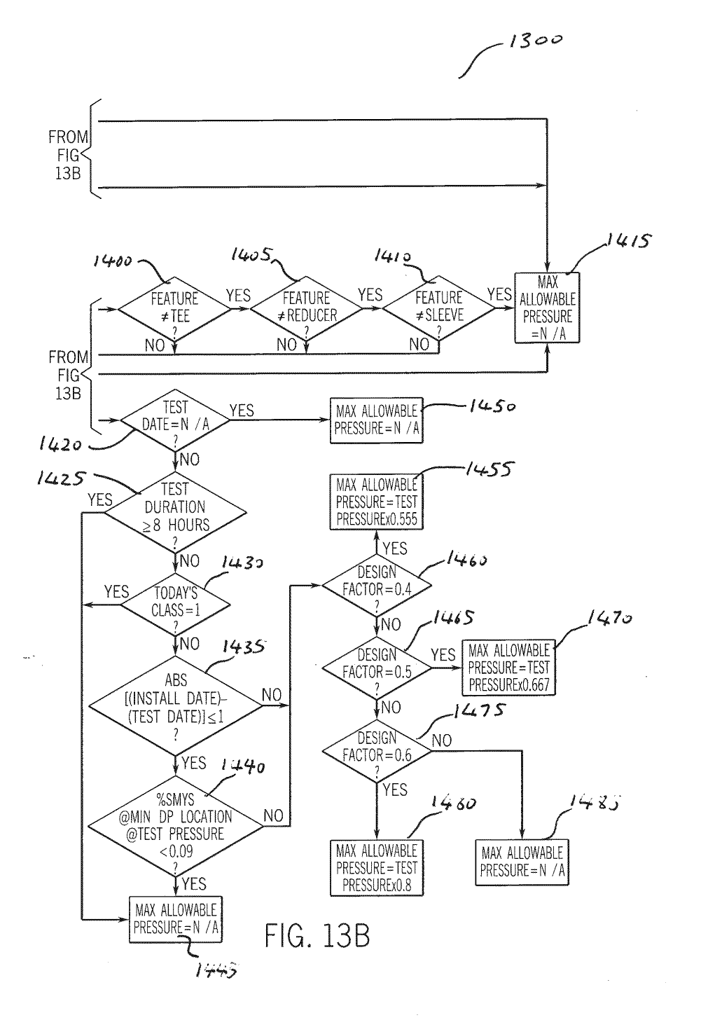

FIGS. 13A-13B are a flow chart 1300 showing the raw maximum allowable pressure determination according to one embodiment of the invention. In accordance with this embodiment, the illustrated combination flow chart 1300 includes a number of decision points 1305, 1310, 1315, 1320, 1325, 1330, 1335, 1340, 1345, 1350, 1355, 1360, 1365, 1370, 1373, 1380, 1385, 1390, 1395, 1400, 1405, 1410, 1420, 1425, 1430, 1435, 1440, 1460, 1465, and 1475 that lead to setting a value for a maximum allowable pressure. In some embodiments, a determination 1305 can ascertain if test pressure equals N/A. If the answer is positive, then maximum allowable pressure equals N/A (1415). If the answer is negative, then a determination 1310 can ascertain if seam type equals furnace butt weld. If the answer is positive, then determination 1315 can ascertain if install date is greater than or equal to Oct. 13, 1964. If the answer is positive, then maximum allowable pressure equals N/A (1415). In some embodiments, if determinations 1310 or 1315 are negative, then determination 1325 can test if feature does not equal pipe. If the answer is positive, then determination 1330 can ascertain if feature does not equal field bend. If the answer is positive, then determination 1335 can ascertain if feature does not equal manufacturer bend. If the answer is positive, then determination 1400 can ascertain if feature does not equal tee. If the answer is positive, then determination 1405 can ascertain if feature does not equal reducer. If the answer is positive, then determination 1410 can ascertain if feature does not equal sleeve. If the answer is positive, maximum allowable pressure equals N/A (1415). In some embodiments, if any of determinations 1325, 1330, 1335, 1400, 1405, or 1410 are negative, a determination 1320 can test if fitting MAOP does not equal N/A. If the answer is positive, maximum allowable pressure equals N/A (1415). If the answer is negative, then determination 1340 can ascertain if % SMYS at 1 is less than or equal to 0.6. If the outcome is positive, then a determination 1345 can ascertain if % SMYS at 2 equals N/A. If the outcome is negative, then a determination 1350 can ascertain if % SMYS at 2 is less than or equal to 0.6. If determinations 1345 or 1350 are positive, then a determination 1355 can test for today's class. If the outcome is positive, then maximum allowed pressure equals N/A (1375). If either of determinations 1340, 1350 or 1355 are negative, then a determination 1360 can ascertain if % SMYS at 1 is less than or equal to 0.5. If the outcome is positive, then a determination 1365 can ascertain if % SMYS at 2 equals N/A. If the outcome is negative, then a determination 1370 can ascertain if % SMYS at 2 is less than or equal to 0.5. If determinations 1365 or 1370 are positive, then a determination 1373 can test for today's class 3. If the outcome is positive, then maximum allowed pressure equals N/A (1375). In some embodiments, if either of determinations 1360, 1370 or 1373 are negative, then a determination 1380 can ascertain if % SMYS at 1 is less than or equal to 0.4. If the outcome is positive, then a determination 1385 can ascertain if % SMYS at 2 equals N/A. If the outcome is negative, then a determination 1390 can ascertain if % SMYS at 2 is less than or equal to 0.4. If determinations 1385 or 1390 are positive, then a determination 1395 can test for today's class 4. If the outcome is positive, then maximum allowed pressure equals N/A (1375). If either of determinations 1380, 1390 or 1395 are negative, then a determination 1420 can ascertain if test data equals N/A. If the answer is positive, then maximum allowable pressure equals N/A. Conversely, upon a negative outcome, a determination 1425 can ascertain if test duration is greater than or equal to 8 hours. If the answer is positive, then maximum allowable pressure equals N/A. If the answer is negative, then a determination 1430 can ascertain if today's class equals 1. If the answer is positive, then maximum allowable pressure equals N/A. If the answer is negative, then a determination 1435 can ascertain ABS install date test minus test data is less than or equal to 1. If the answer is positive, then a determination 1440 can ascertain if % SMYS at minimum DP location at test pressure is less than 0.09. If the answer is positive, then maximum allowable pressure equals N/A. If either of determinations 1435 or 1490 are negative, then a determination 1460 can ascertain if design factor equals 0.4. If the answer is positive, then maximum allowable pressure equals test pressure multiplied by 0.555 (1455). If the answer is negative, then a determination 1465 can ascertain if design factor equals 0.5. If the answer is positive, then maximum allowable pressure equals test pressure multiplied by 0.667 (1470). If the answer is negative, then a determination 1475 can ascertain if design factor equals 0.6. If the answer is negative, then maximum allowable pressure equals N/A (1485). If the answer is positive, then maximum allowable pressure equals test pressure multiplied by 0.8 (1480).

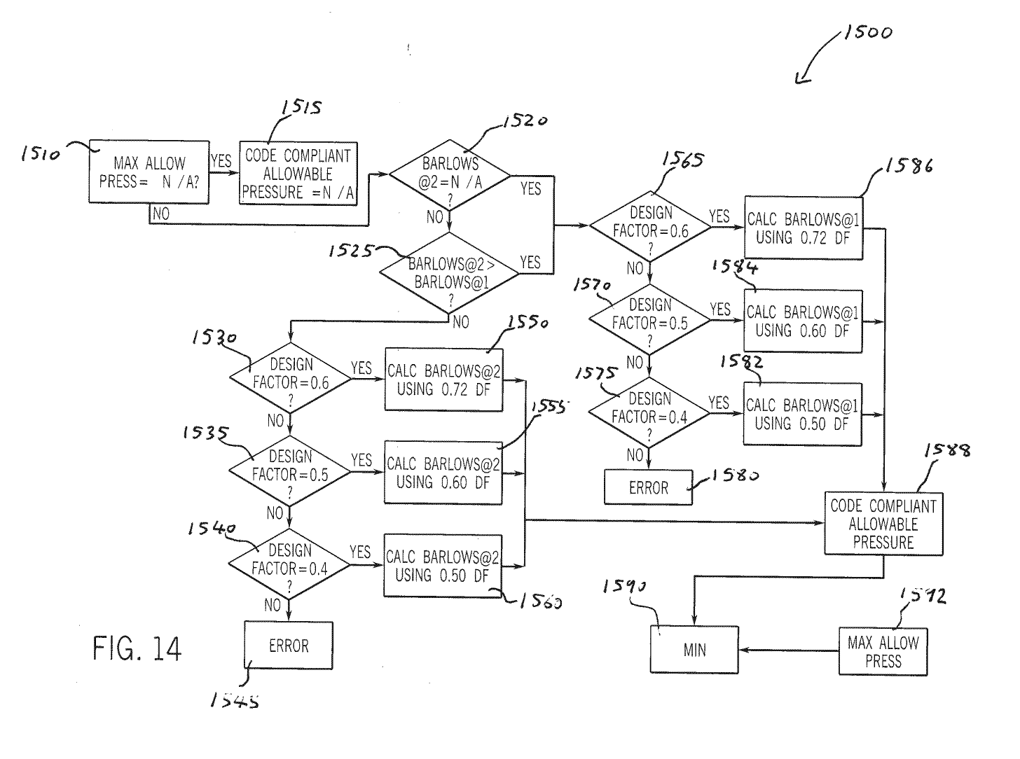

FIG. 14 is a flow chart 1500 showing the calculation process for 1 class out code compliant allowable pressure according to one embodiment of the invention. As shown, the flow chart 1500 includes determinations 1520, 1525, 1530, 1535, 1540, 1665, 1570, and 1575. In some embodiments, a determination 1510 can ascertain if maximum allowable pressure equals N/A. If the answer is positive, then code compliant allowable pressure equals N/A (1515). If the answer is negative, then a determination 1520 can ascertain if Barlows at 2 equals N/A. If the answer is negative, then a determination 1525 can ascertain if Barlows at 2 is greater than Barlows at 1. If the answer is negative, then a determination 1530 can ascertain if design factor equals 0.6. If the answer is positive, then the method can include calculation of Barlows at 2 using 0.72 DF (1550), code compliant allowable pressure (1588), min (1590), and max allow pressure (1592). If the answer is negative, then a determination 1535 can ascertain if design factor equals 0.5. If the answer is positive, then the method can include calculation of Barlows at 2 using 0.6 DF (1555), code compliant allowable pressure (1588), min (1590), and max allow pressure (1592). If the answer is negative, then a determination 1540 can ascertain if design factor equals 0.4. If the answer is positive, then the method can include calculation of Barlows at 2 using 0.5 DF (1560), code compliant allowable pressure (1588), min (1590), and max allow pressure (1592).

In some embodiments, if the determinations 1520 or 1525 are positive, then a determination 1565 can ascertain if design factor equals 0.6. If the answer is positive, then the method can include calculation of Barlows at 1 using 0.72 DF (1586), code compliant allowable pressure (1588), min (1590), and max allow pressure (1592). If the answer is negative, then a determination 1570 can ascertain if design factor equals 0.5. If the answer is positive, then the method can include calculation of Barlows at 1 using 0.6 DF (1584), code compliant allowable pressure (1588), min (1590), and max allow pressure (1592). If the answer is negative, then a determination 1575 can ascertain if design factor equals 0.4. If the answer is positive, then the method can include calculation of Barlows at 1 using 0.5 DF (1582), code compliant allowable pressure (1588), min (1590), and max allow pressure (1592). If determination 1575 is negative, then error (1580).

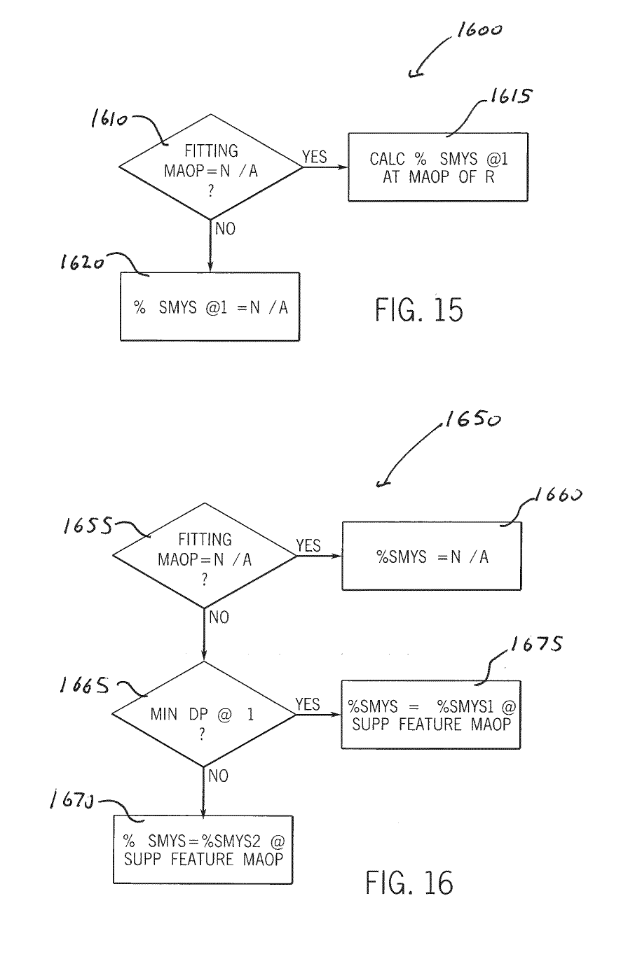

FIG. 15 is a flow chart 1600 showing the % SMYS at 1 according to one embodiment of the invention. More specifically, if the value of a fitting MAOP equals N/A (determination 1610), then % SMYS at 1 is calculated using the MAOP of record (1615), otherwise, % SMYS at 1 is equal to N/A.

FIG. 16 is a flow chart 1650 showing the % SMYS according to one embodiment of the invention. In accordance with this embodiment, % SMYS is calculated at the minimum DP location using supported feature MAOP. Up to two decision points 1655, 1665 are used to determine a value for % SMYS. As shown, in some embodiments, a determination 1655 can ascertain if fitting MAOP equals N/A. If the answer is positive, % SMYS equals N/A (1660). If the answer is negative, a determination 1665 can ascertain if minimum DP at 1. If the answer is positive, then % SMYS equals % SMYS1 at supported feature MAOP (1675), otherwise, then % SMYS equals % SMYS2 at supported feature MAOP (1670).

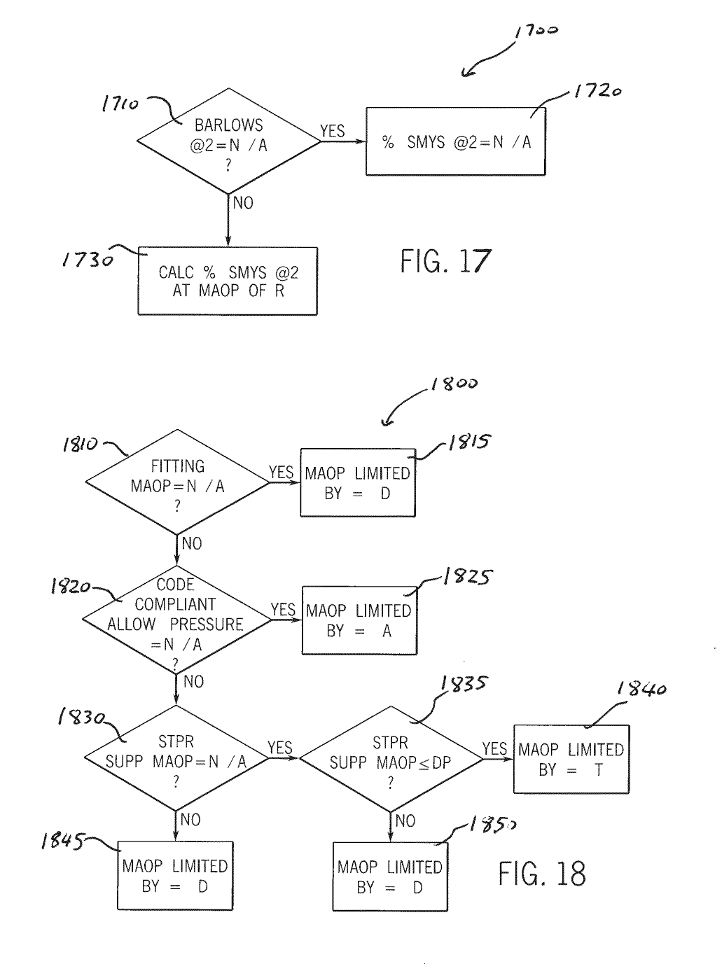

FIG. 17 is a flow chart 1700 showing the % SMYS @ 2 according to one embodiment of the invention. A decision block 1710 determines whether BARLOWS at 2 equals N/A, and sets the N/A value of % SMYS at 2 if that is the case. Otherwise, the % SMYS at 2 is calculated at the MAOP of record.

FIG. 18 is a flow chart 1800 showing how the MAOP is limited according to one embodiment of the invention. Specifically, the process illustrated in FIG. 18 follows the same general logic as FIG. 11. As shown, the method includes determinations 1810, 1820, 1830, and 1835. In some embodiments, a determination 1810 tests if fitting MAOP equals N/A. If yes, then MAOP limited by equals D (1815). If no, then a determination 1820 can ascertain if code compliant allowable pressure equals N/A. If yes, then MAOP limited by equals A (1825). If no, then a determination 1830 STPR supported MAOP equals N/A is performed. Upon a negative outcome, MAOP limited by equals D. If determination 1830 is positive, then a determination 1835 can ascertain if STPR supported MAOP is less than or equal to DP. If a negative outcome then MAOP limited by equals D (1850), otherwise, MAOP limited by equals T (1840).

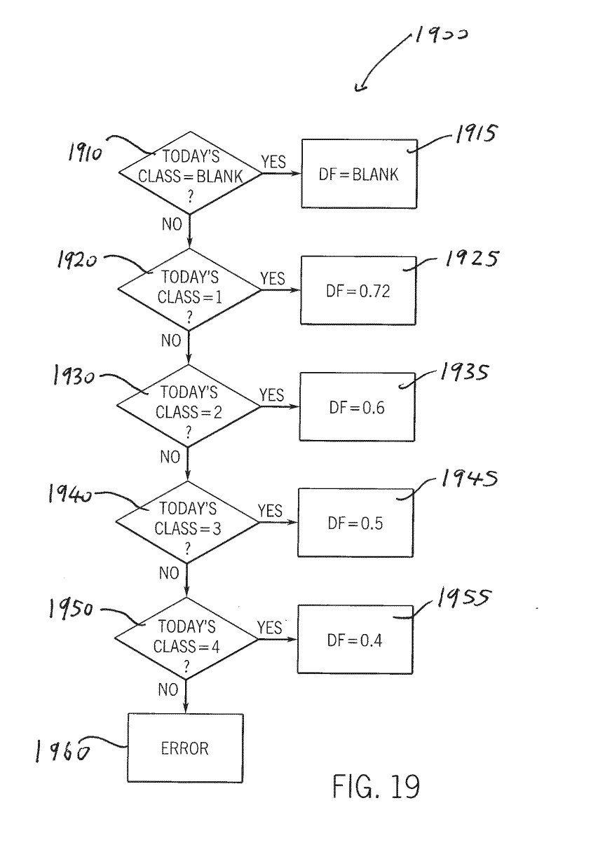

FIG. 19 is a flow chart 1900 showing the design factor calculation according to one embodiment of the invention. According to this embodiment, the process shown in FIG. 19 determines a DF value based on a number of decision points 1910, 1920, 1930, 1940, 1950, 1960 relating to if the pipe is installed before or on/after Jul. 1, 1961, in road, on bridge, or in station. In some embodiments, a determination 1910 is can ascertain if todays class equals blank, and if yes, DF equals blank (1915). If no, then a determination 1920 can ascertain if todays class equals 1. The outcome is positive, then DF equals 0.72 (1925). If no, then a determination 1930 can ascertain if todays class equals 2. If the outcome is positive, then DF equals 0.6 (1935). If no, then a determination 1940 can ascertain if todays class equals 3. If the outcome is positive, then DF equals 0.5 (1945). If no, then a determination 1950 can ascertain if todays class equals 4. If the outcome is positive, then DF equals 0.4 (1955), and if not, then error (1960).

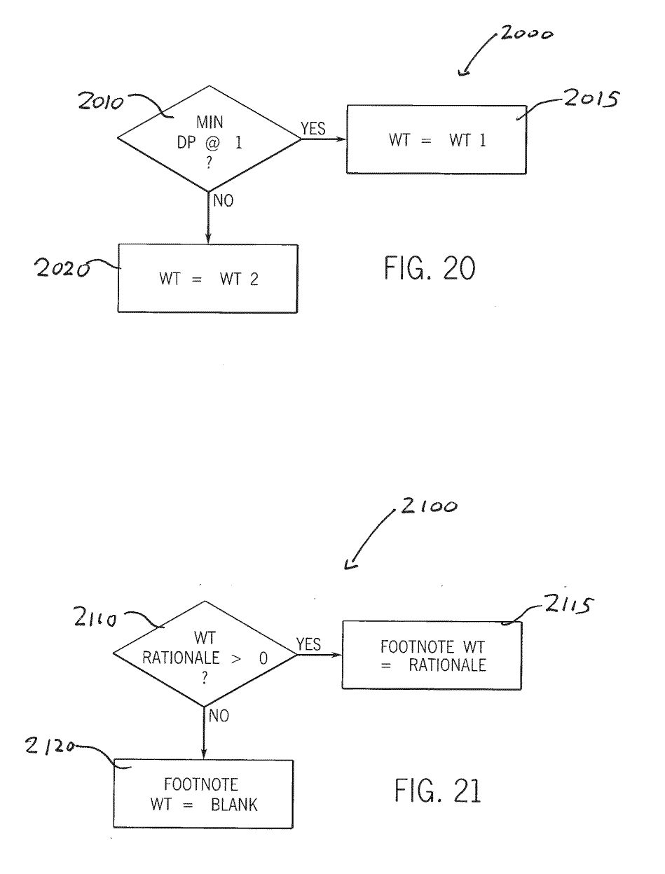

FIG. 20 is a flow chart 2000 showing the WT—MAOP report according to one embodiment of the invention. Specifically, the process of FIG. 20 sets the WT value based on whether the minimum DP value is at one (2010). If yes, then WT is equal to WT 1 (2015), otherwise, WT equals WT 2 (2020).

FIG. 21 is a flow chart 2100 showing the WT footnote—MAOP report according to one embodiment of the invention. Specifically, the process of FIG. 21 sets the footnote WT value based on whether the WT rational value is greater than zero. If yes, then the footnote WT equals rational (2115), otherwise, footnote WT equals blank (2120).

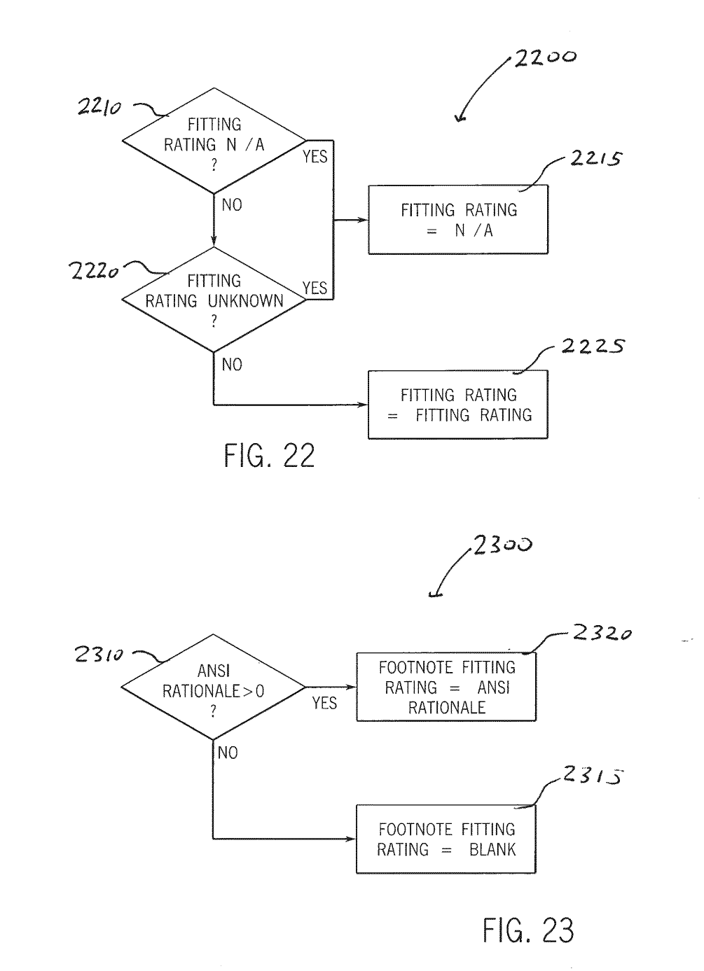

FIG. 22 is a flow chart 2200 showing the fitting rating—MAOP report according to one embodiment of the invention. In one embodiment, the process illustrated in FIG. 22 sets the value of a fitting rating based on determining whether the fitting value is N/A or is unknown (2210, 2220). If true, then the fitting rating equals N/A. Otherwise, the fitting rating is as specified (i.e., the fitting rating equals the fitting rating) (see for example, 2225).

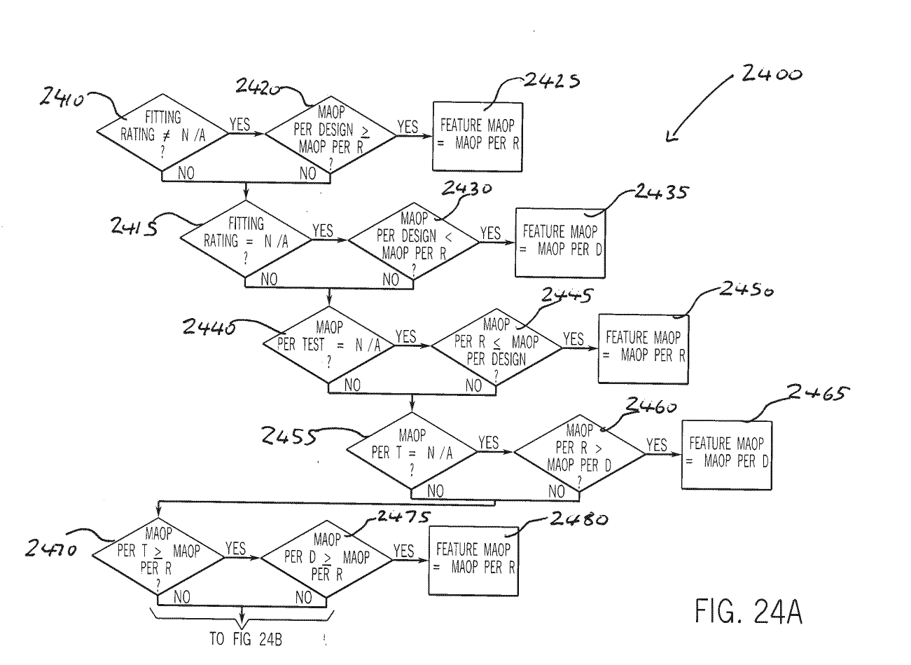

FIG. 23 is a flow chart 2300 showing the footnote fitting rating—MAOP report according to one embodiment of the invention. More specifically, FIG. 23 illustrates setting the footnote fitting rationale to ANSI rationale when the ANSI rationale value is greater than zero (2320, by determination 2310), otherwise it is blank (2315).

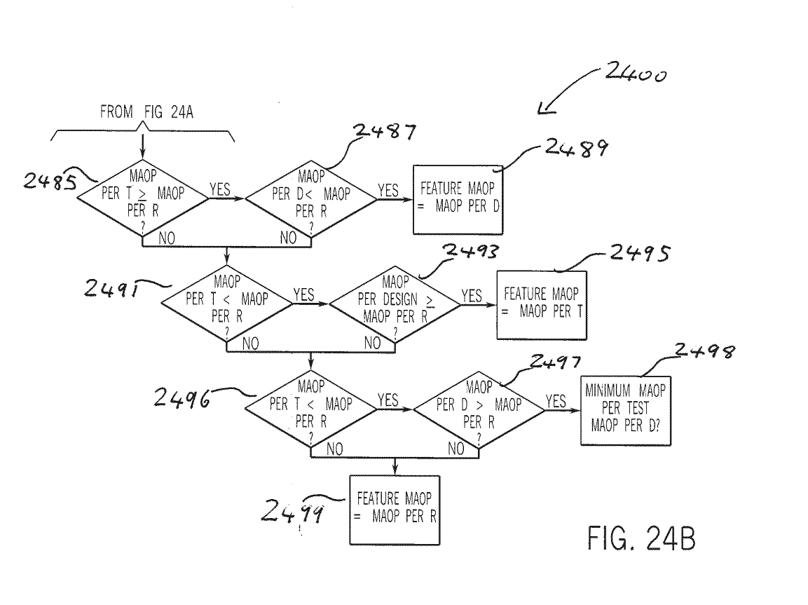

FIGS. 24A-24B are a flow chart 2400 showing the feature MAOP—MAOP report according to one embodiment of the invention. Specifically, the process as illustrated in FIG. 24 calculates a value for feature MAOP based on comparing MAOP per design, MAOP per record, and MAOP per test. As shown, the method includes various determinations 2410, 2420, 2415, 2430, 2440, 2445, 2455, 2460, 2470, 2475, 2485, 2487, 2491, 2493, 2496, and 2497. In some embodiments, determination 2410 can ascertain if fitting rating does not equal N/A. If the outcome is positive, then a determination 2420 can ascertain if MAOP per design is less than or MAOP per R, and if so, feature MAOP equals MAOP per R (2425). If determinations 2410, 2420 are negative, then a determination 2415 can ascertain if fitting rating equals N/A. If the outcome is positive, then a determination 2445 can ascertain if MAOP per R is less than or equal to MAOP per design, and if so, feature MAOP equals MAOP per R (2450). In some embodiments, if determinations 2440, 2445 are negative, then a determination 2455 can ascertain if MAOP per T equals N/A. If yes, then a determination 2460 can ascertain if MAOP per R is greater than MAOP per D, and if so, then feature MAOP equals MAOP per D (2465). If either determinations 2455, 2460 are negative, then a determination 2470 can ascertain if MAOP per T is greater than or equal to MAOP per R. If yes, then a determination 2475 can ascertain if MAOP per D is greater than or equal to MAOP per R, and if yes, feature MAOP equals MAOP per R (2480). In some embodiments, if either of determinations 2470, 2475 are negative, then determination 2485 can ascertain if MAOP per T is greater than or equal to MAOP per R. If yes, then a determination 2487 can ascertain if MAOP per D is less than MAOP per R, and if so, feature MAOP equals MAOP per D (2489). In some embodiments, if either determinations 2485, 2487 are negative, then a determination 2491 can ascertain if MAOP per T is less than MAOP per R. If the outcome is positive, then a determination 2493 can ascertain if MAOP per design is greater than or equal to MAOP per R, and if yes, feature MAOP equals MAOP per T (2495). In some embodiments, if either determinations 2491 or 2493 are negative, then a determination 2496 can ascertain if MAOP per T is less than MAOP per R. If the outcome is positive, then a determination 2497 can assess if MAOP per D is greater than MAOP per R, and if yes, then minimum MAOP per test MAOP per test D? (2498). However, if determinations 2496 or 2497 are negative, then feature MAOP equals MAOP per R (2499).

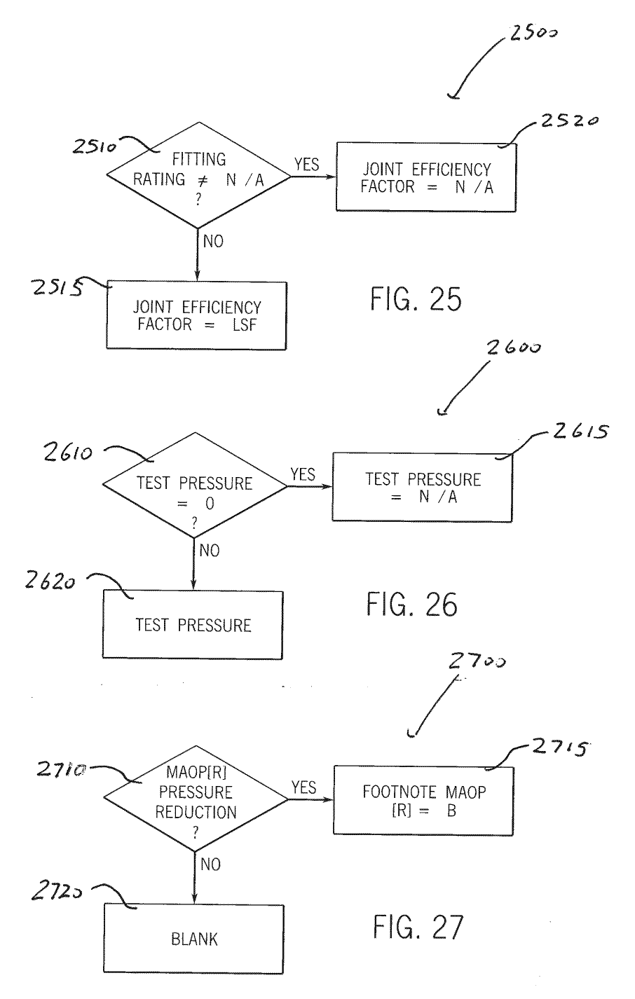

FIG. 25 is a flow chart 2500 showing the joint efficiency factor—MAOP report according to one embodiment of the invention. More specifically, the process of FIG. 25 sets a joint efficiency factor to either N/A or LSF based on whether a fitting rating is equal to N/A (by determination 2510). As shown, if through determination 2510 it is shown that fitting rating does not equal N/A, then joint efficiency factor equals N/A (2520), otherwise, joint efficiency factor equals LSF (2515).

FIG. 26 is a flow chart 2600 showing the test pressure—MAOP report according to one embodiment of the invention. A determination 2610 is made as to whether a test pressure equals zero and sets the test pressure value to N/A if that is the case (2615), or outputs test pressure if not (2620).

FIG. 27 is a flow chart 2700 showing the footnote MAOP [R]—MAOP report according to one embodiment of the invention. In one embodiment, footnote MAOP [R] value is set to B (2715) when a MAOP [R] pressure reduction determination 2710 is positive or output is blank if not (2720).

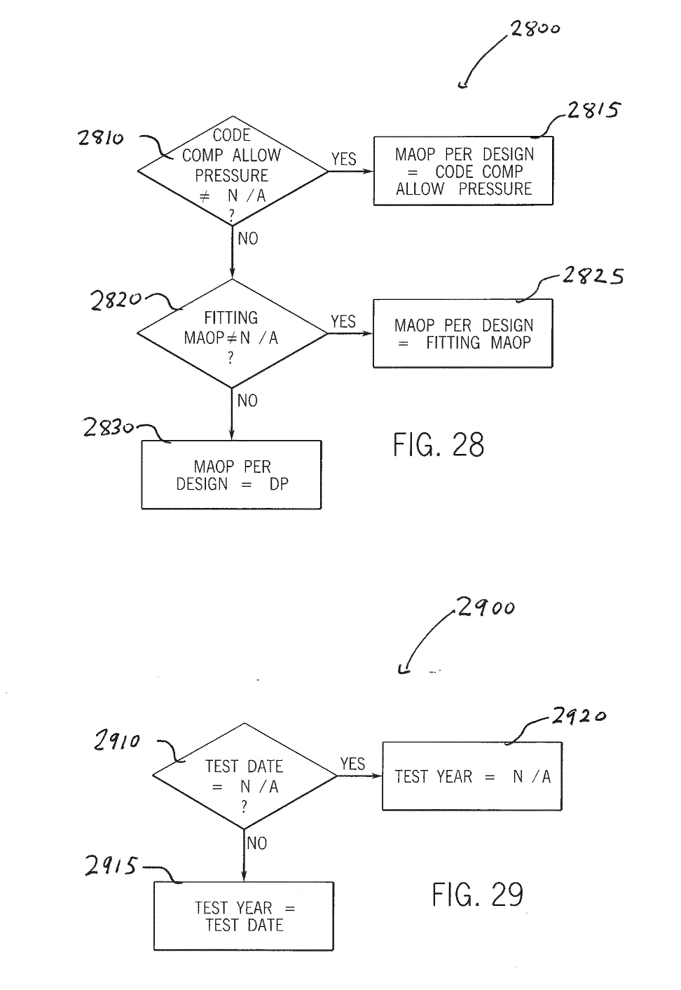

FIG. 28 is a flow chart 2800 showing the MAOP per design—MAOP report according to one embodiment of the invention. Specifically, the process of FIG. 28 sets a MAOP per design value (through determinations 2810, 2820) based on: 1) whether code comp allow pressure value is not equal to N/A, then it equals code compliant allowable pressure if it is (2815); and 2) whether a fitting MAOP value is not equal to N/A (determination 2820), then it equals fitting MAOP if it is (2825). If neither is true, then the MAOP per design value is set to DP (2830).

FIG. 29 is a flow chart 2900 showing test year—MAOP report according to one embodiment. Specifically, the process 2900 of FIG. 29 sets the test year equal to the year of the test date if the test date is applicable (2915), or alternatively, the test date is equal to N/A (2920).

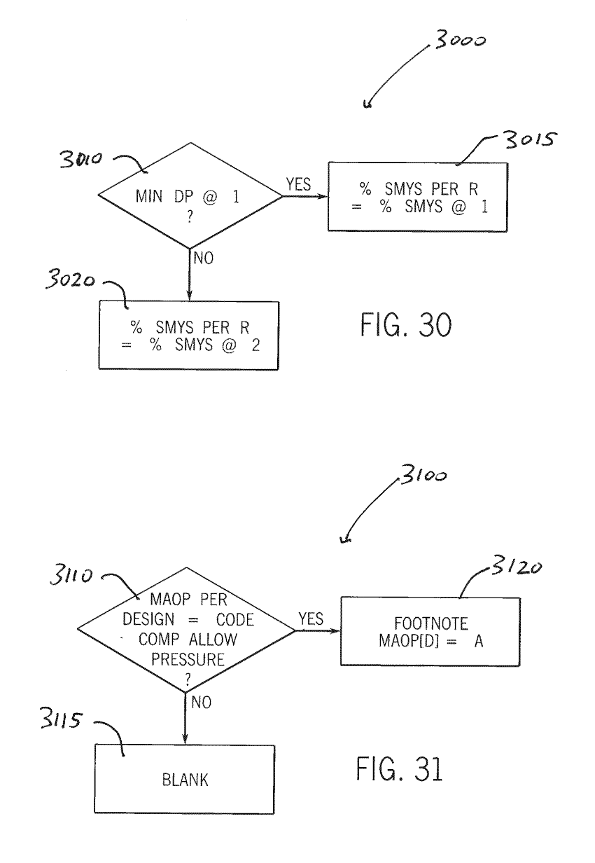

FIG. 30 is a flow chart 3000 showing the % SMYS Per R—MAOP report according to one embodiment. In accordance with this embodiment, % SMYS per R is calculated using MAOP per record at minimum DP location. For example, if a determination 3010 ascertains the minimum DP is 1, then % SMYS per R equals % SMYS at 1 (3015), otherwise, % SMYS per R equals % SMYS at 2 (3020).

FIG. 31 is a flow chart 3100 showing the footnote MAOP [D]—MAOP report according to one embodiment of the invention. As shown, if a MAOP per design value is equal to code comp allow pressure (through a determination 3110), then footnote MAOP [D] value is set to A (3120), otherwise the result is blank (3115).

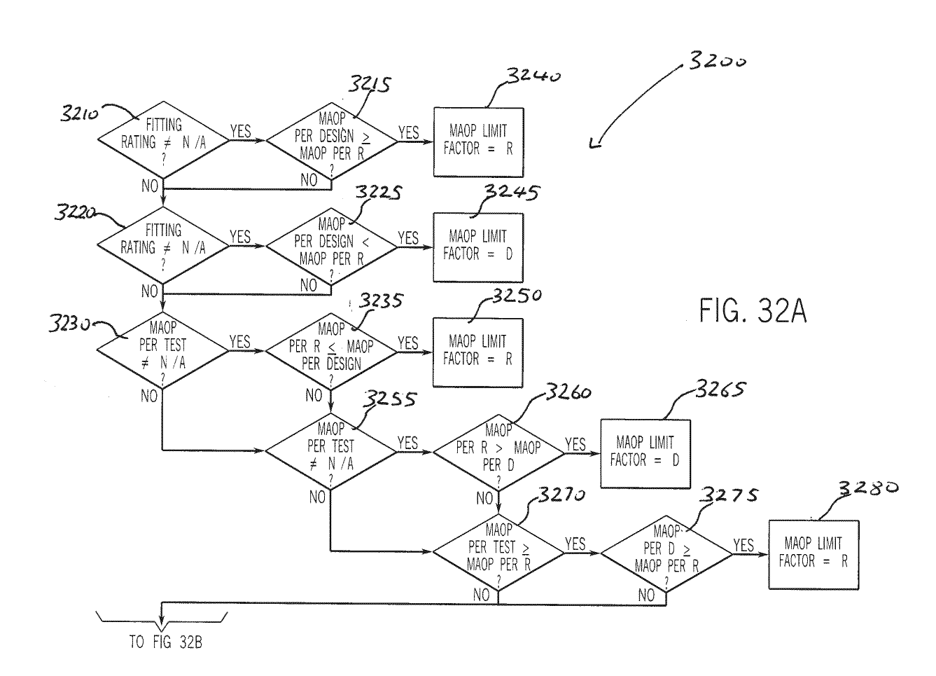

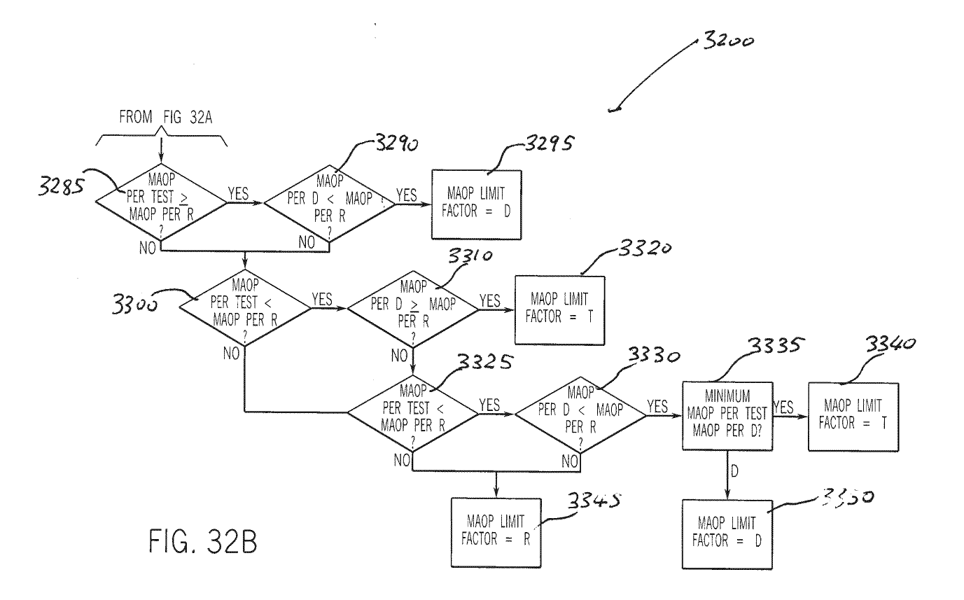

FIGS. 32A-32B are a flow chart 3200 showing the MAOP limit factor—MAOP report according to one embodiment. The process of FIG. 32 sets a MAOP limit factor value based on comparing MAOP per design, MAOP per record, and MAOP per test. As shown, the method detailed in flow chart 3200 can include determinations 3210, 3215, 3220, 3225, 3230, 3235, 3255, 3260, 3270, 3275, 3285, 3290, 3300, 3310, 3325, and 3330. In some embodiments, a determination 3210 can assess if fitting rating does not equal N/A. If the outcome is positive, then a determination 3215 can ascertain if MAOP per design is greater than or equal to MAOP per R. If the answer is positive, then MAOP limit factor equals R. In some embodiments, if determinations 3210, 3215 are negative, then a determination 3220 can assess if fitting rating does not equal N/A. If the outcome is positive, then a determination 3225 can ascertain if MAOP per design is less than MAOP per R. If the answer is positive, then MAOP limit factor equals D (3245). In some embodiments, if determinations 3220, 3225 are negative, then a determination 3230 can assess if MAOP per test does not equal N/A. If the outcome is positive, then a determination 3235 can ascertain if MAOP per R is less than or equal to MAOP per design. If the answer is positive, then MAOP limit factor equals R (3250). In some embodiments, if determinations 3230, 3235 are negative, then determination 3255 can assess if MAOP per test does not equal N/A. If the outcome is positive, then a determination 3260 can assess if MAOP per R is greater than MAOP per D. If the answer is positive, then MAOP limit factor equals D (3265). In some embodiments, if determinations 3255, 3260 are negative, then a determination 3270 can ascertain if MAOP per test is greater than or equal to MAOP per R. If the outcome is positive, then a determination 3275 can assess if MAOP per D is greater than or equal to MAOP per R. If the outcome is positive, then MAOP limit factor equals R. In some embodiments, if determinations 3270, 3275 are negative, then a determination 3285 can assess if MAOP per test is greater than or equal to MAOP per R. If the answer is positive, then a determination 3290 can assess if MAOP per D is less than MAOP per R. If the answer is positive, then MAOP limit factor equals D (3295). In some embodiments, if either determination 3285, 3290 is negative, then a determination 3300 can assess if MAOP per test is less than MAOP per R. If the outcome is positive, then a determination 3310 can assess if MAOP per D is greater than or equal to MAOP per R, and if so, the MAOP limit factor equals T (3320). If the outcome of determinations 3300, 3310 is negative, then a determination 3325 can ascertain if MAOP per test is less than MAOP per R. If the outcome is positive, then a determination 3330 can ascertain if MAOP per D is less than MAOP per R. If the outcome of either determinations 3325, 3330 is negative, then MAOP limit factor equals R (3345). In some embodiments, if the outcome of determination 3330 is positive, then a determination 3335 can ascertain if minimum MAOP per test MAOP per D?, and if so, MAOP limit factor equals T (3340), otherwise, MAOP limit factor equals D (3350).

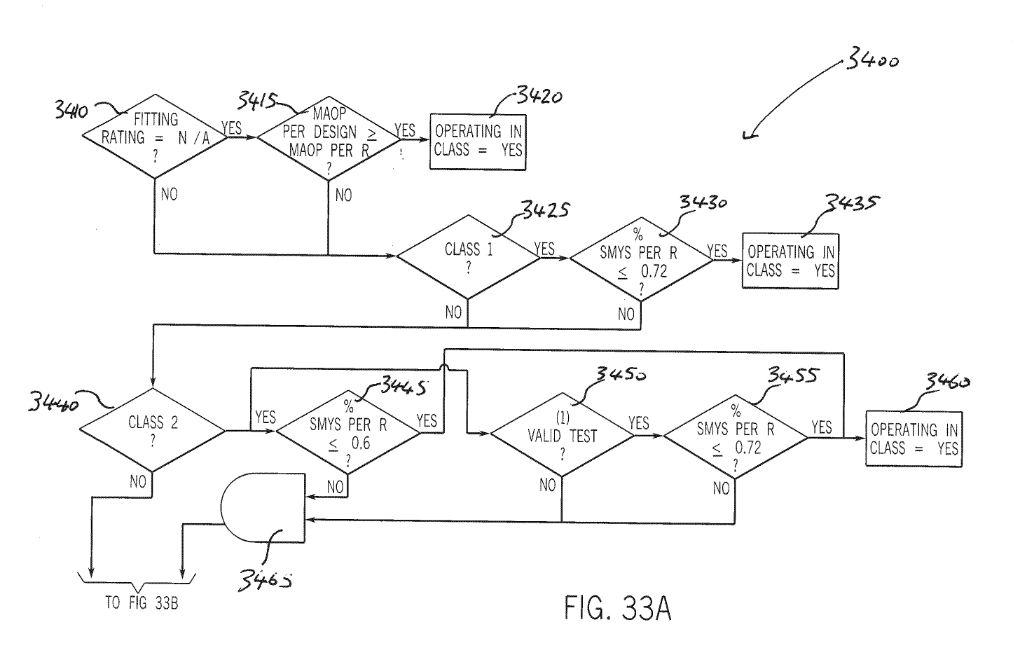

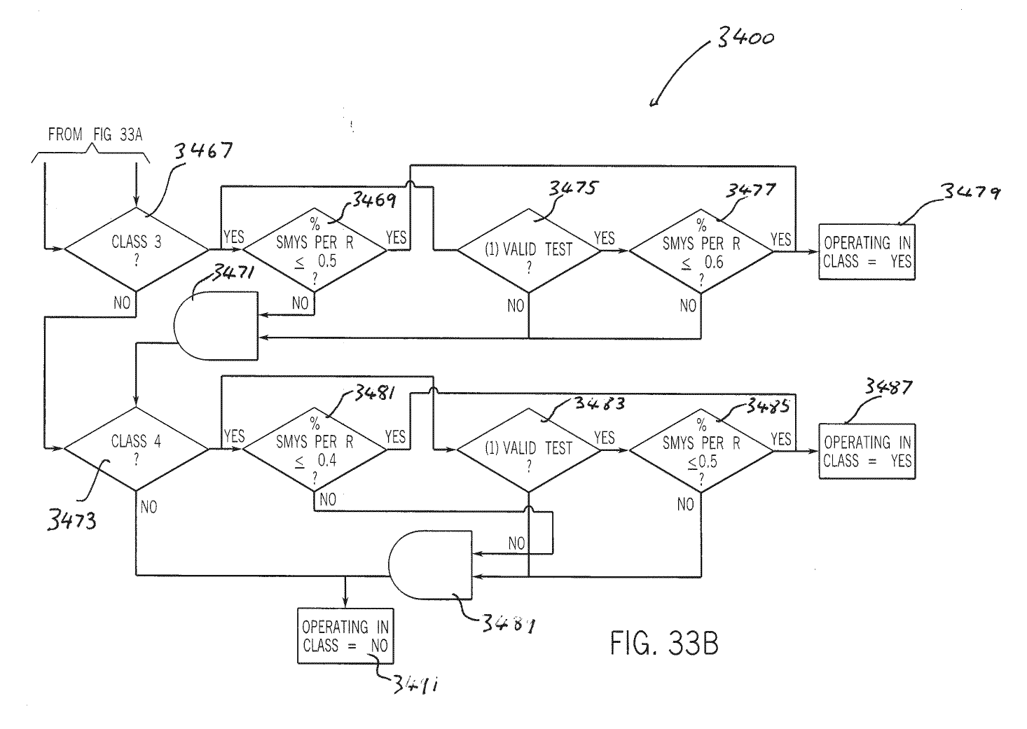

FIGS. 33A-33B illustrate a flow chart 3400 showing the operating in class—MAOP report according to one embodiment. Specifically, the system calculates a “Yes” or “No” value for operating in class based on whether % SMYS is within limits for the current class, if operating 1 class out, or if % SMYS is less than or equal to the 1 class out calculation. As shown, the method depicted in flow chart 3400 can include determinations 3410, 3415, 3425, 3430, 3440, 3445, 3450, 3455, 3467, 3469, 3475, 3477, 3473, 3481, 3483, 3485, and nand operations 3465, 3471, and 3489. In some embodiments, a determination 3410 can make an assessment if fitting rating equals N/A. For a positive outcome, a determination 3415 can assess if MAOP per design is greater than or equal to MAOP per R. If the answer is yes, then operating in class equals “yes” (3420). In some embodiments, if either determinations 3410, 3415 are negative, then a determination 3425 can assess if the component is a class 1, and if so, a determination 3430 can ascertain if % SMYS per R is less than or equal to 0.72. If the outcome is positive, operating in class equals “yes” (3435). In some embodiments, if either outcome 3425, 3430 is negative, then a determination 3440 can make an assessment for class 2. If the answer is positive, then a determination 3445 can ascertain if % SMYS per R is less than or equal to 0.6, and if the outcome is positive, operating in class is equal to “yes” (3460). Further, upon a positive outcome of determination 3440, a determination 3450 if (1) is a valid test. If the outcome is positive, then a determination 3455 can ascertain if % SMYS per R is less than or equal to 0.72, and if yes, operating in class is equal to “yes” (3460).

In some embodiments, if the outcome of any of determinations 3445, 3450, or 3455 is negative, then the results can be processed with a nand operator 3465. As shown, in some embodiments, if the outcome of determination 3440 is negative, and the output of the nand operator 3465 can be assessed using determination 3467. A positive outcome of determination 3467 can include a determination 3469, in which a positive outcome can include operating in class equal to “yes” (3479). Further, a positive outcome of determination 3467 can lead to a determination 3475, an assessment of (1) valid test. A positive outcome of determination 3475 can include a determination 3477 including an assessment if % SMYS per R is less than or equal to 0.6. A positive outcome leads to operating in class equal to “yes” (3479). As shown, negative outcomes of determinations 3469, 3475, 3477 lead through a nand operation 3471. In some embodiments, if the determination 3467 is negative, the results, along with the output of nand operation 3471 can include a determination 3472 to assess class 4. A positive outcome can proceed to a determination 3481, leading to operating in class equals “yes” if the outcome is positive (3487). Further, in some embodiments, a positive outcome of determination 3473 can lead to a determination 3483, assessing (1) valid test. A positive outcome of determination 3483 can lead to determination 3485, in which a positive outcome leads to operating in class equals “yes” (3487). In some embodiments, negative outcomes of determinations 3481, 3483 and 3485 lead to a nand operation 3489. In some embodiments the results of the nand operation lead to operation in class equals “no”. This same results applies if the earlier described determination 3473 is negative.

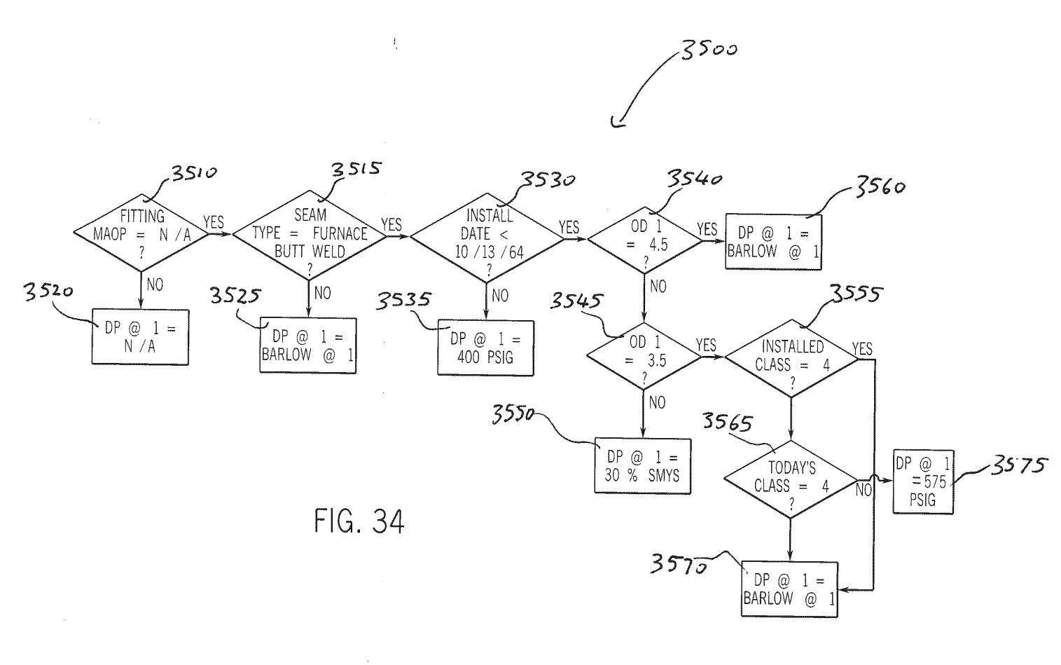

FIG. 34 is a flow chart 3500 showing the calculated DP @ 1 according to one embodiment of the invention. In accordance with this embodiment, a DP @ 1 value is set according to a number of decision points as shown in FIG. 34, including determinations 3510, 3515, 3530, 3540, 3545, 3555, 3565. As shown, in some embodiments, a determination 3510 can ascertain if fitting MAOP equals N/A. If not, then DP at 1 equals N/A (3520). For a positive outcome, a determination 3515 can ascertain if seam type equals furnace butt weld. If the outcome is negative, DP at 1 equals barlow at 1 (3525). In some embodiments, if the outcome is positive, then a determination 3530 can assess if the install date is less than Oct. 13, 1964. If the answer is no, then DP at 1 equals 400 pounds per square inch gauge. If the outcome is positive, then a determination 3540 can assess if OD 1 equals 4.5. If the answer is yes, then DP at 1 equals barlow at 1 (3560). If the answer is no, then a determination 3545 can assess if OD 1 equals 3.5. If the answer is negative, then DP @ 1 equals 30% SMYS. If the answer is positive, then a determination 3555 can ascertain of installed class equals 4. If the answer is yes, then DP at 1 equals barlow at 1 (3570). If the answer is no, then a determination 3565 can ascertain if today's class equals 4. If not, then the result is DP at 1 equals 575 pounds per square inch gauge.

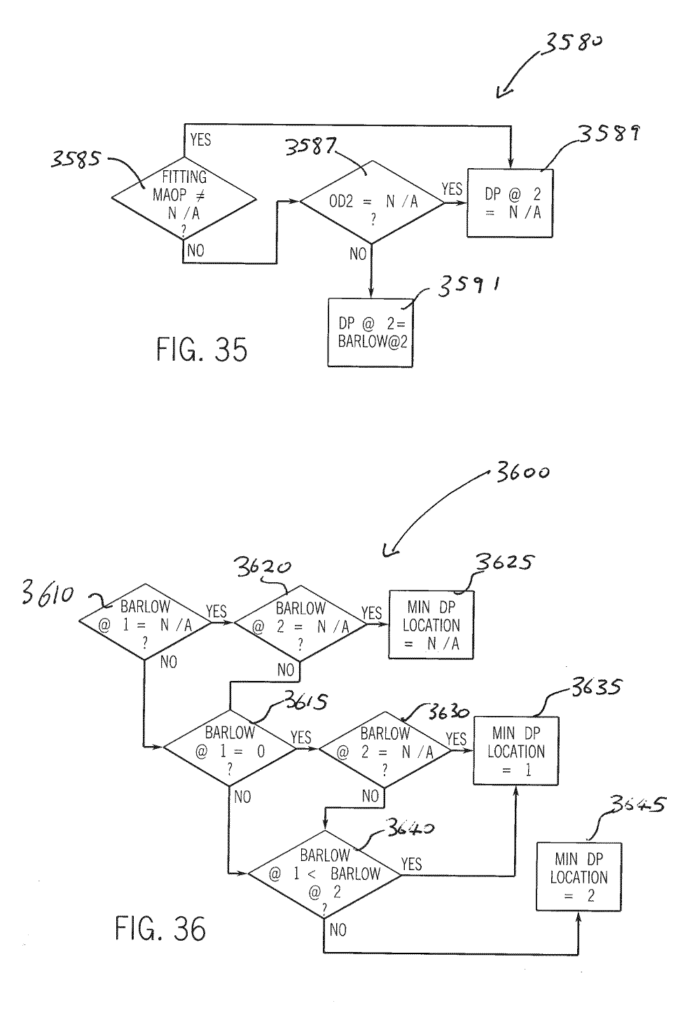

FIG. 35 is a flow chart 3580 showing the calculated DP @ 2 according to one embodiment of the invention. As shown, DP @ 2 is calculated based on whether a fitting MAOP is equal to N/A if “yes” through determination 3585, then N/A and whether the OD2 value is equal to N/A (determination 3587). In some embodiments, if the determination 3585 is positive, then DP at 2 equals N/A. Conversely, if the determination is negative, then a determination 3587 can ascertain if OD 2 equals N/A. For a negative outcome, DP at 2 equals barlow at 2 (3591), otherwise, DP at 2 equals N/A (3589).

FIG. 36 is a flow chart 3600 showing the minimum DP location according to one embodiment of the invention. As shown, in some embodiments, the minimum DP location is set according to a number of decision points 3610, 3620, 3615, 3630, 3640 for determining the value of barlow @ 1 and barlow @ 2. For example, in some embodiments, a determination 3610 can ascertain if barlow at 1 equals N/A. In some embodiments, through determination 3620, if barlow at 2 equals N/A, then minimum DP location equals N/A (3625). In some embodiments, if either determinations 3610, 3620 are negative, a determination 3615 can assess if barlow at 1 equals zero, and if so, a determination 3630 can assess if barlow at 2 equals N/A. If determination 3630 is positive, then minimum DP location equals 1. In some embodiments, if either determination 3615 or 3630 are negative, then a determination 3640 can ascertain if barlow at 1 is less than barlow at 2. For a positive outcome, then minimum DP location equals 1, otherwise then minimum DP location equals 2.

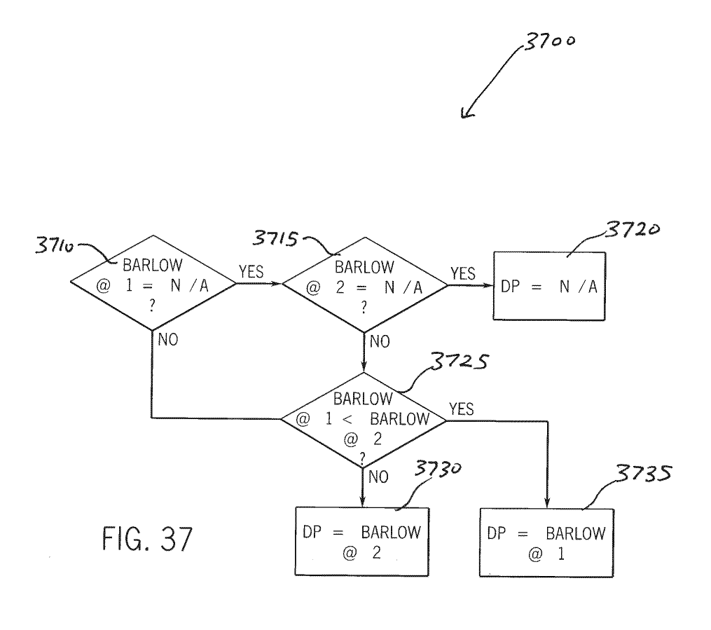

FIG. 37 is a flow chart 3700 showing the DP according to one embodiment of the invention. Specifically, FIG. 37 illustrates a process for setting the DP value by determining the values of barlow @ 1 and barlow @ 2, and comparing the two with the smaller value equal to DP. As shown process shown in FIG. 37 includes determinations 3710, 3715, and 3725. In some embodiments, the determination 3710 can ascertain if barlow at 1 equals N/A. For a positive outcome, a determination 3715 can ascertain if barlow at 2 equals N/A, from which a positive outcome yields a result of DP equals N/A (3720). In some embodiments, if determinations 3710, 3715 yield a negative outcome, then a determination 3725 can ascertain if barlow at 1 is less than barlow at two. As shown, a positive outcome yields DP equals barlow at 1 (3735), and a negative outcome yields DP equals barlow at 2.

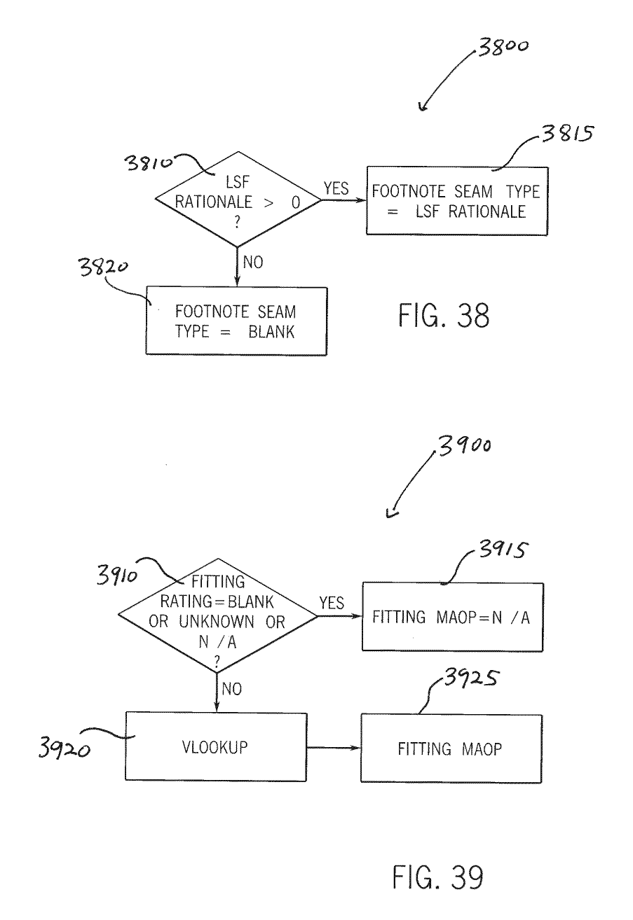

FIG. 38 is a flow chart 3800 showing the seam type footnote—MAOP report according to one embodiment of the invention. As shown, a footnote seam type value is set based on whether a LSF rationale value is greater than zero (determination 3810). If true, then footnote is set to that value (3815), otherwise, footnote seam type equals blank (3820).

FIG. 39 is a flow chart 3900 showing the fitting MAOP according to one embodiment of the invention. In this embodiment, the fitting MAOP value is set to N/A (3915) when a fitting rating equals a blank or unknown value using determination 3910. Otherwise, fitting MAOP is the value from a lookup table with WOG/ANSI values (3920, 3925).

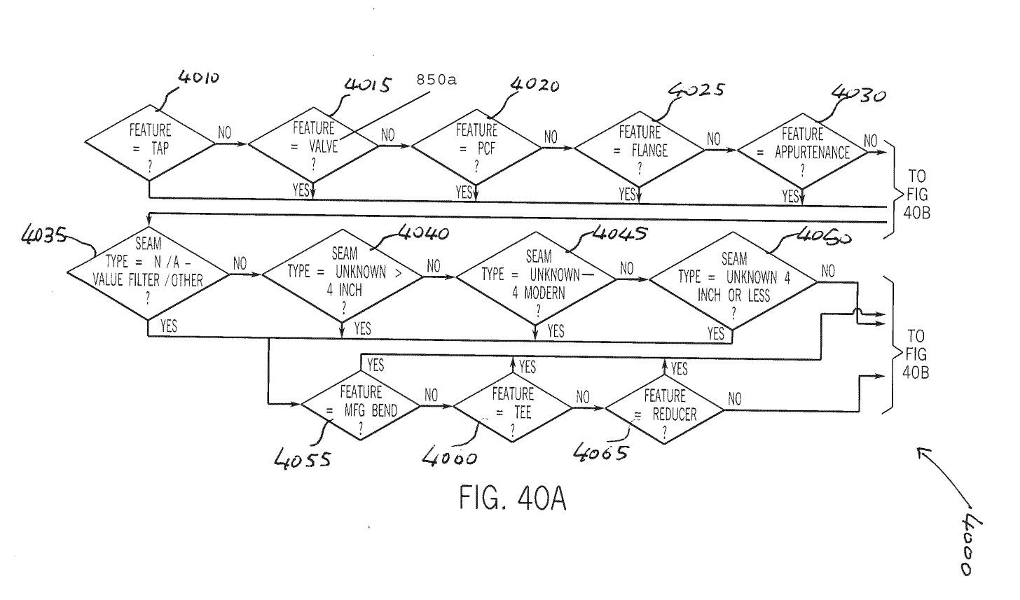

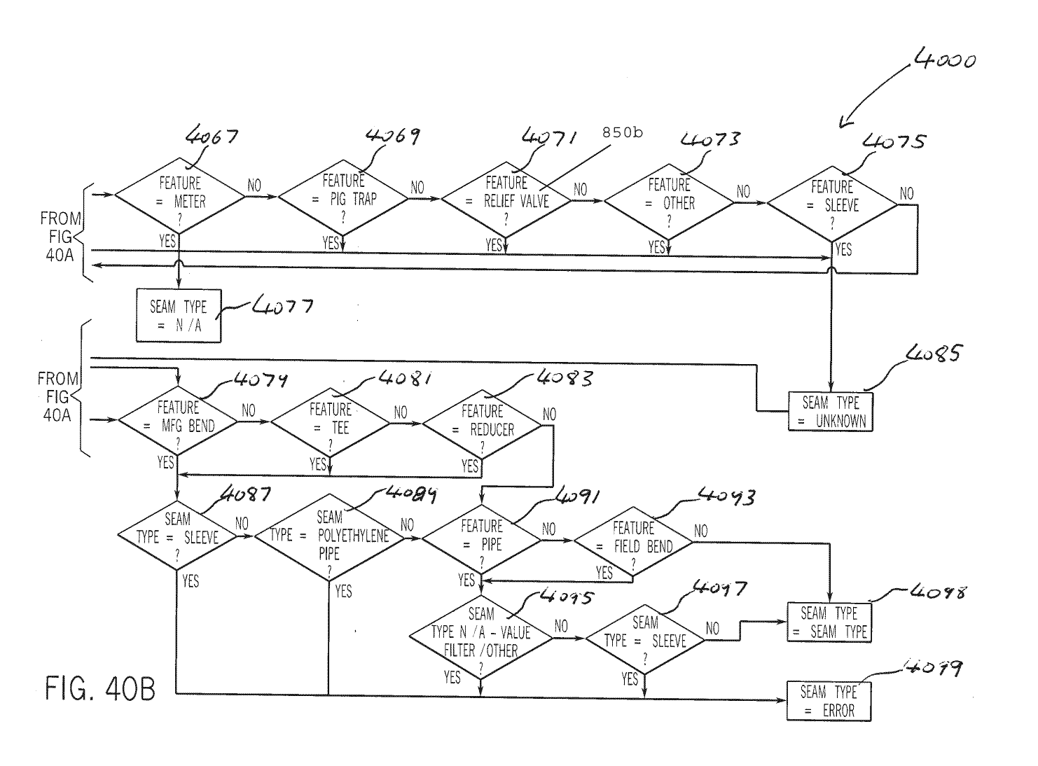

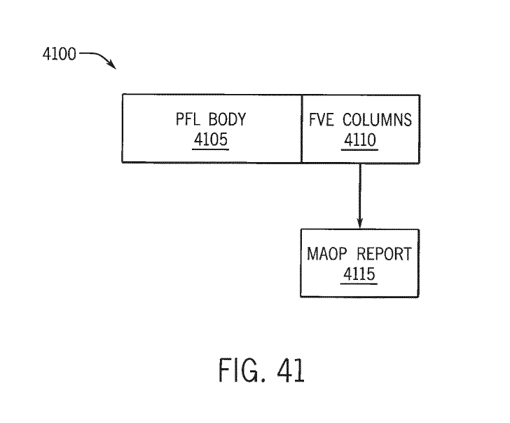

FIGS. 40A-40B are a flow chart 4000 showing the seam type according to one embodiment of the invention. Specifically FIG. 40 comprises a number of decision points 4010, 4015, 4020, 4025, 4030, 4035, 4040, 4045, 4050, 4055, 4060, 4065, 4067, 4069, 4071, 4073, 4075, 4079, 4081, 4083, 4087, 4089, 4091, 4093, 4095, and 4097 for ultimately determining a value for seam type. The decision points 4010, 4015, 4020, 4025, 4030, 4035, 4040, 4045, 4050, 4055, 4060, 4065, 4067, 4069, 4071, 4073, 4075, 4079, 4081, 4083, 4087, 4089, 4091, 4093, 4095, and 4097 consider a number of calculations and variables relating to features and seams. For example, in some embodiments, a determination 4010 can ascertain if feature equals tap. If the outcome is positive, then seam type equals unknown (4085). However if the outcome is negative, then a determination 4015 can ascertain if feature equals valve 850a. If the outcome is positive, then seam type equals unknown (4085). However if the outcome is negative, then a determination 4020 can ascertain if feature equals PCF. If the outcome is positive, then seam type equals unknown (4085). However if the outcome is negative, then a determination 4025 can ascertain if feature equals flange. If the outcome is positive, then seam type equals unknown (4085). However if the outcome is negative, then a determination 4030 can ascertain if feature equals appurtenance. If the outcome is positive, then seam type equals unknown (4085). However if the outcome is negative, then a determination 4067 can ascertain if feature equals meter. If the outcome is positive, then seam type equals N/A (4077). However if the outcome is negative, then a determination 4069 can ascertain if feature equals pig trap. If the outcome is positive, then seam type equals unknown (4085). However if the outcome is negative, then a determination 4071 can ascertain if feature equals relief valve 850b. If the outcome is positive, then seam type equals unknown (4085). However if the outcome is negative, then a determination 4073 can ascertain if feature equals other. If the outcome is positive, then seam type equals unknown (4085). However if the outcome is negative, then a determination 4075 can ascertain if feature equals sleeve. If the outcome is positive, then seam type equals unknown (4085). However if the outcome is negative, then a determination 4035 can ascertain if seam type equals N/A—value filter/other. If the outcome is negative, then a determination 4040 can ascertain if seam type equals unknown greater than 4 inch. If the outcome is negative, then determination 4045 can assess if seam type equals unknown greater than four inches minus modern. If the outcome is negative then a determination 4050 can ascertain if seam type equals unknown 4 inches or less. In some embodiments, the outcome for 4050, or if any of determinations 4035, 4040, 4045 are positive, a determination 4055 can assess if feature equals manufacturers bend. If the outcome is negative, a determination 4060 can assess if feature equal tee. If the outcome is negative, a determination 4065 can assess if feature equals reducer. In some embodiments, if any of determinations 4055, 4060, or 4065 are positive, then seam type equals unknown (4085). Further, if any of determinations 4050, 4065 are negative, then a determination 4079 can assess if feature equals manufacturers bend. If the outcome is negative, then a determination 4081 can assess if feature equals tee. If the outcome is negative, a determination 4083 can assess if feature equals reducer. In some embodiments, if any of determinations 4079, 4081 or 4083 are positive, then a determination 4087 can ascertain if seam type equals sleeve. For a negative outcome, a determination 4089 can assess if seam type equals polyethylene pipe. In some embodiments, for positive outcomes of determinations 4087, 4089, seam type equals error (4099). Moreover, for negative outcomes of determinations 4083 and 4089, a determination 4091 can assess if feature equals pipe. For a negative outcome a determination 4093 can assess if feature equals field bend, in which a negative outcome yields a seam type equals seam type (4098). In some embodiments, if either of determinations 4091, 4093 are positive, a determination 4095 can assess if seam type equals N/A minus value filter/other. For a negative outcome, a determination 4097 can assess if seam type equals sleeve, in which a negative outcome equates to seam type equals seam type. Finally, in some embodiments, if either of determinations 4095, 4097 are positive, then seam type equals error (4099).

FIG. 41 is a block schematic 4100 showing the structure for the analysis template and MAOP report 4115 including the pipeline features, PFL Body 4105, and FVE columns 4110 according to one embodiment of the invention. Specifically, FIG. 41 is a high-level view of the inter-relationships of the MAOP report 4115 with the PFL body (pipeline feature list) 4105 and FVE columns 4115.

In some embodiments, the PFL body 4105 maintains data that is populated, edited, and revised by one or more designated entities and/or teams such as, for example, the PFL build and quality control teams. The data in the PFL Body 4105 includes known data from verifiable sources such as as-built drawings, STPR, plat Sheets, and the like.

In one embodiment, the data in the PFL body 4105 includes stationing and MPs; segment identifier numbers; class locations; pip specifications; purchase and installation information; strength test information; relevant images; drawings, plat sheets, etc.; and PFL build/quality control engineering comments.

In one embodiment, an FVE assigned to an issues resolution team can review, revise, and/or add data to the FVE Columns 4110. In some embodiments, the FVE columns 4110 may auto-populate with information provided in the PFL body and data added by an FVE member could originate from a document (e.g., as built), dig/direct inspection results, or may be based on historical data (i.e., PRUPF). In one embodiment, for unknown data in the PFL body, the FVE members may utilize an assumptions macro, for example, to generate suggestions for missing pipe specifications. The suggestions may be based on a defined procedure for resolving unknown pipe features (i.e., PRUPF). Moreover, and in one embodiment, the assumptions macro may be embedded in the FVE PFL template.

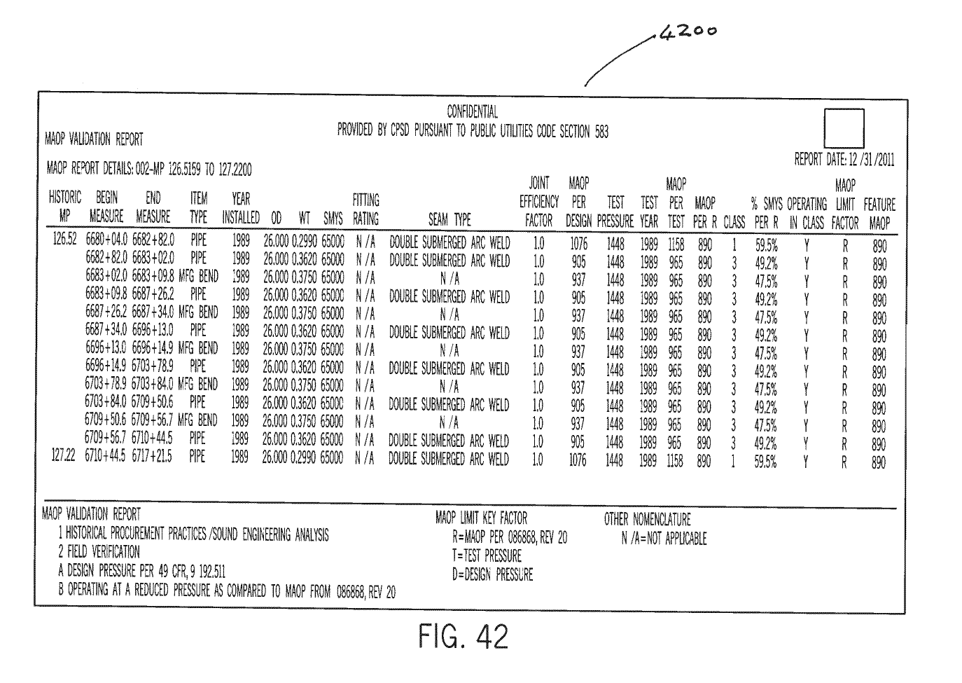

FIG. 42 is a spreadsheet showing the MAOP report structure according to one embodiment of the invention. In accordance with this embodiment, the embedded MAOP report calculator generates an MAOP report. Moreover, in some embodiments, macros may be implemented to generate a final MAOP report and summary report as other tabs in the worksheet. Practitioners will appreciate that a report may naturally include a greater or lesser degree of detail without departing from the scope of the invention.

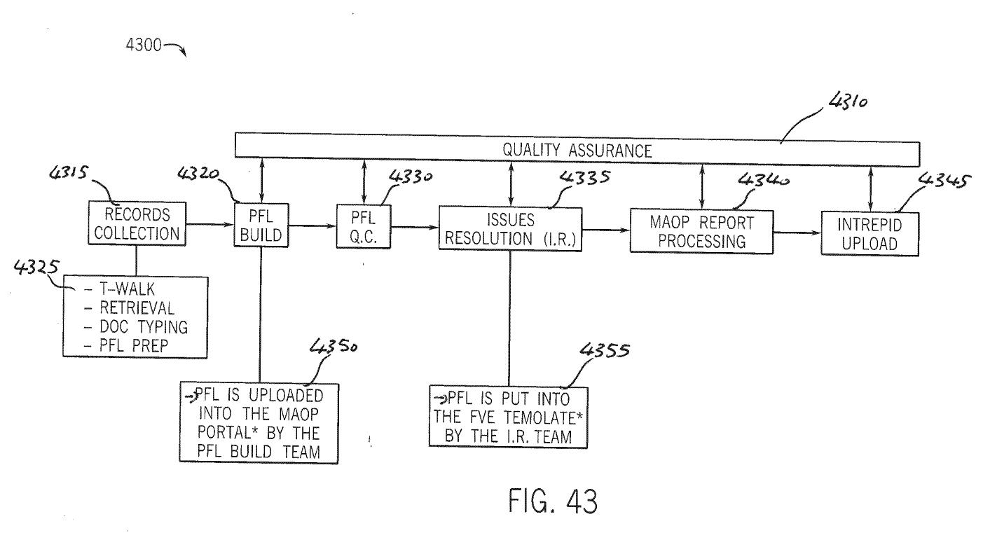

FIG. 43 is a flow chart 4300 showing the process for the MAOP data validation project according to one embodiment of the invention. In one embodiment, the disclosed system includes an MAOP portal, which tracks PFLs from the build team to MAOP report processing through its status and reports/metrics system. The MAOP portal may include workflows that automatically route a PFL to the next person or group in accordance with predefined business rules, for example. As shown, the flow chart 4300 can include a quality assurance block 4310. In some embodiments, quality assurance 4310 can couple with PFL build 4320, PFL Q. C 4330, issues resolution (I.R) 4335, MAOP report processing 4340 and Intrepid™ software upload 4345 functions. Intrepid™ is a trademark of Coler & Colantonio, Inc. In some embodiments, record collections 4315 (linked with functions 4325) can couple to function blocks 4320, 4330, 4335, 4340 4345, and 4310. As shown, functions 4350 can include PFL is uploaded into the MAOP portal* by the PFL build team, and function 4355 can include PFL is put into FVE template* by the I.R. team. Further, in some embodiments, the PFL build 4320 is couple with function 4350, and function 4335 is coupled to the 4355 function.

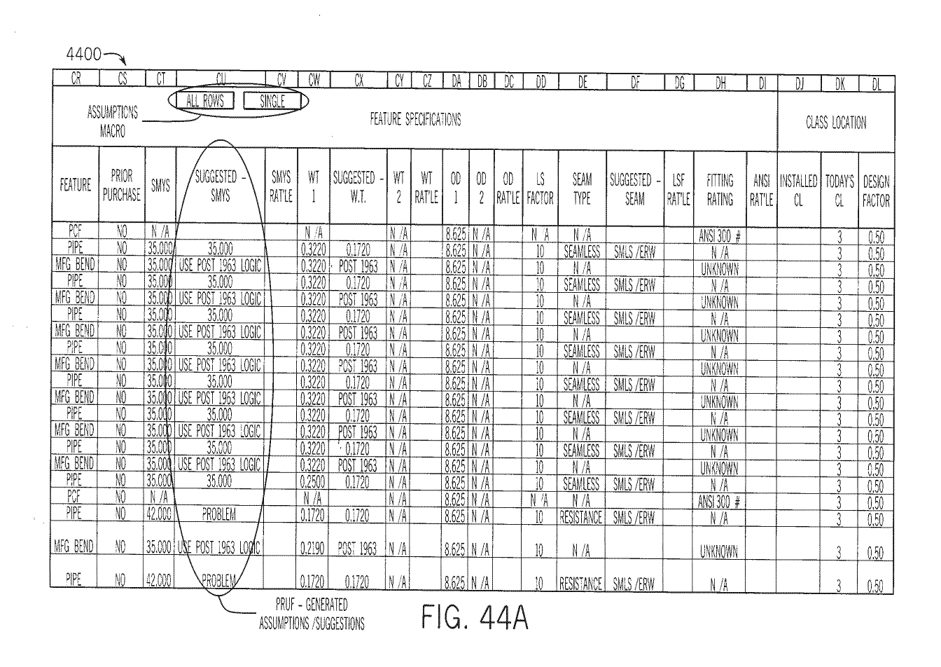

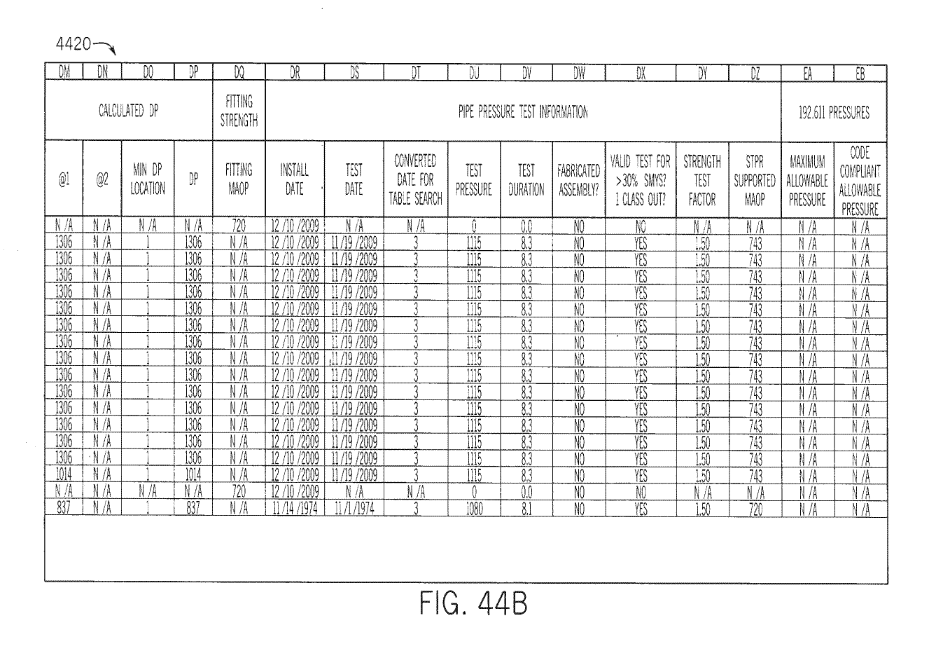

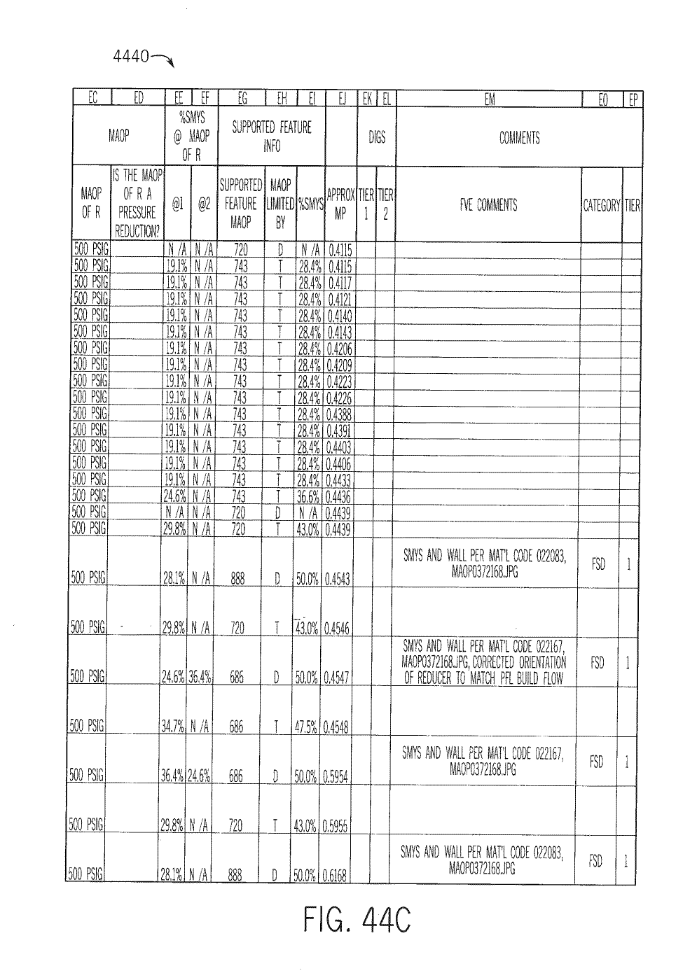

FIGS. 44A-44C is a spreadsheet diagram 4400 showing the feature specifications for the FVE columns according to one embodiment of the invention. In one embodiment, the PRUPF-generated assumptions and/or suggestions may be displayed in a “Suggested-SMYS” column. FIGS. 44B and 44C are continuations of the MAOP report in accordance with one embodiment and are provided to demonstrate the depth and versatility of the types of information included in the disclosed MAOP report. Practitioners will appreciate that a report may naturally include a greater or lesser degree of detail without departing from the scope of the invention. FIGS. 44A-44C is presented to illustrate the culmination of the various data types as identified and calculated in the various processes described above with reference to the preceding Figures.

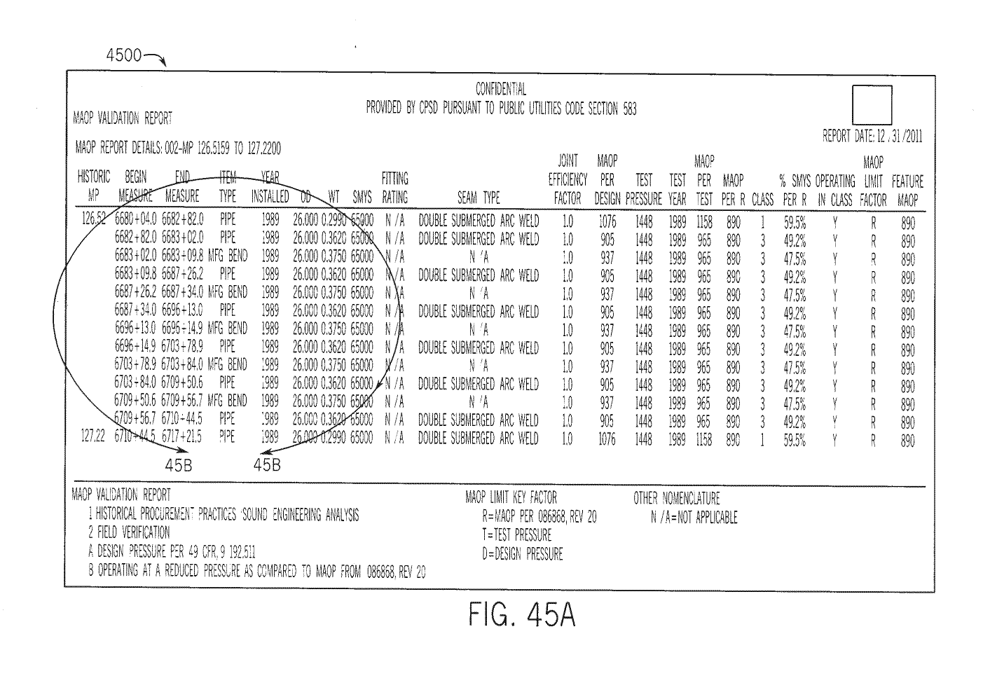

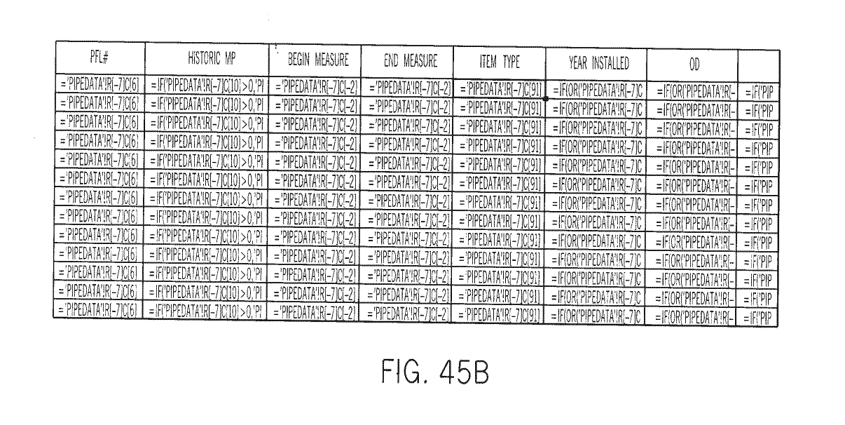

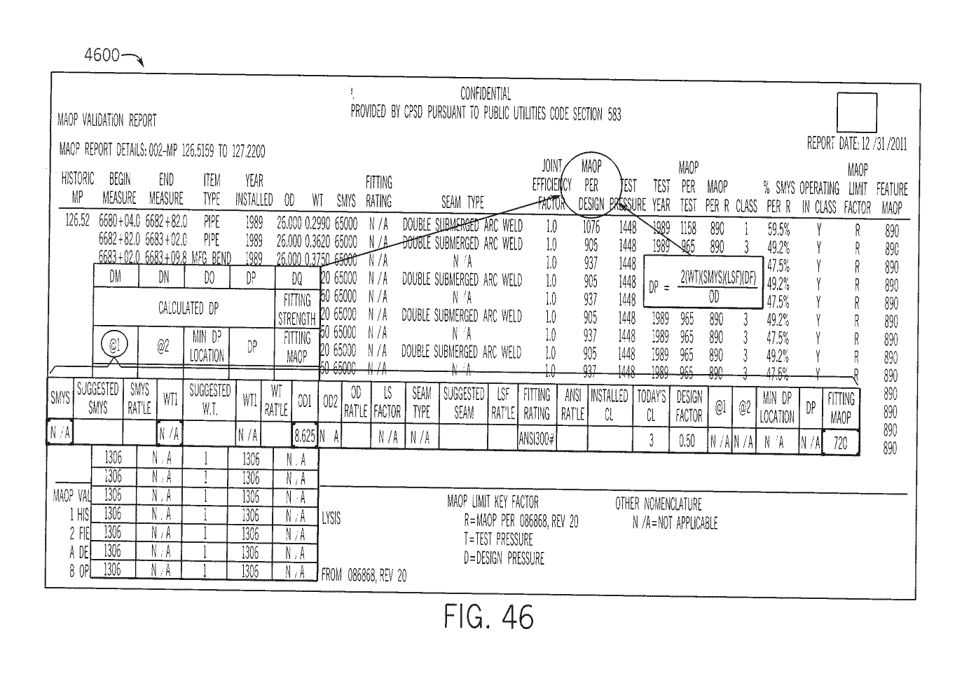

FIGS. 45A-45B shows a spreadsheet diagram 4500 showing the structure for the MAOP report, and FIG. 46 is a spreadsheet diagram 4600 showing design pressure for the MAOP report calculations according to one embodiment of the invention. In one embodiment, the MAOP per design column value may be calculated as illustrated in FIG. 46, with further limitations on DP for reporting purposes being based on date, organizational restrictions, legal codes, class location, and the like. Practitioners will appreciate that a report may naturally include a greater or lesser degree of detail without departing from the scope of the invention.

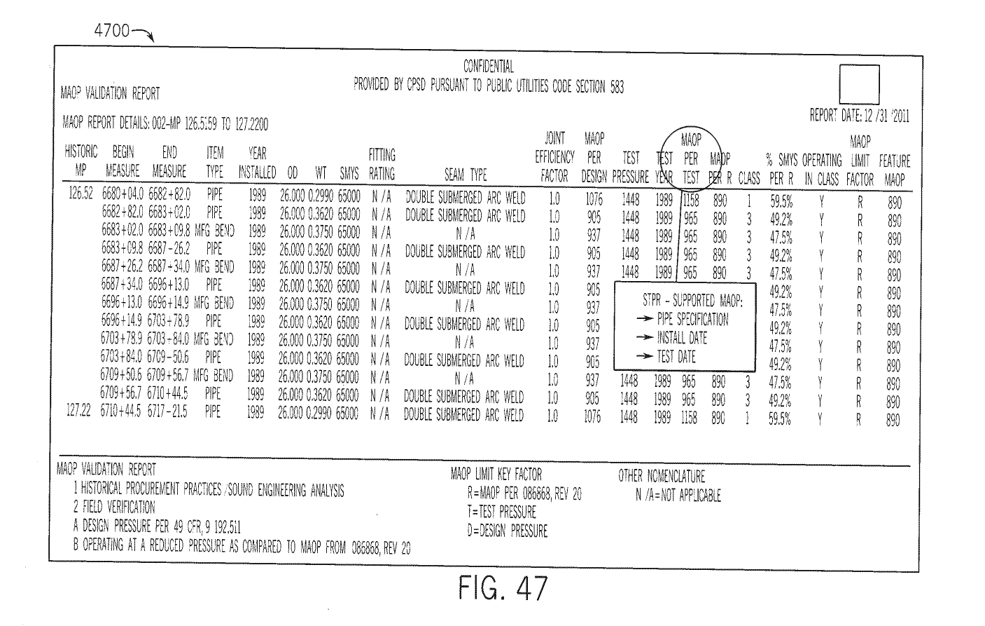

FIG. 47 is a spreadsheet diagram 4700 showing the MAOP per test for the MAOP report calculations according to one embodiment of the invention. In accordance with this embodiment, the MAOP per test column values are derived from STPR—supported MAOP, which includes pipe specification, install date, test date, and test duration. Practitioners will appreciate that a report may naturally include a greater or lesser degree of detail without departing from the scope of the invention.

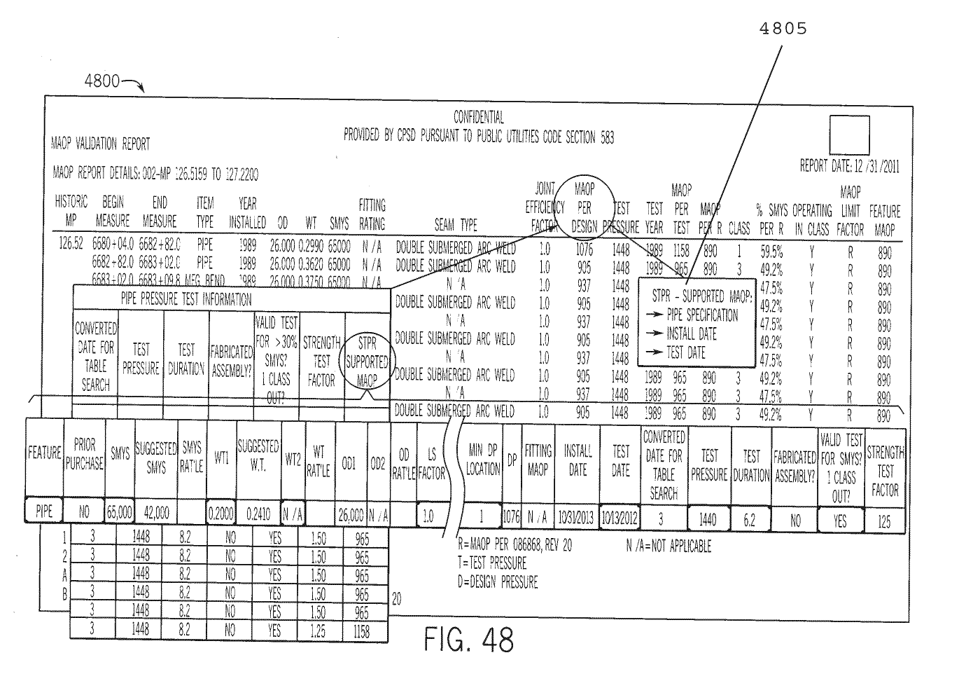

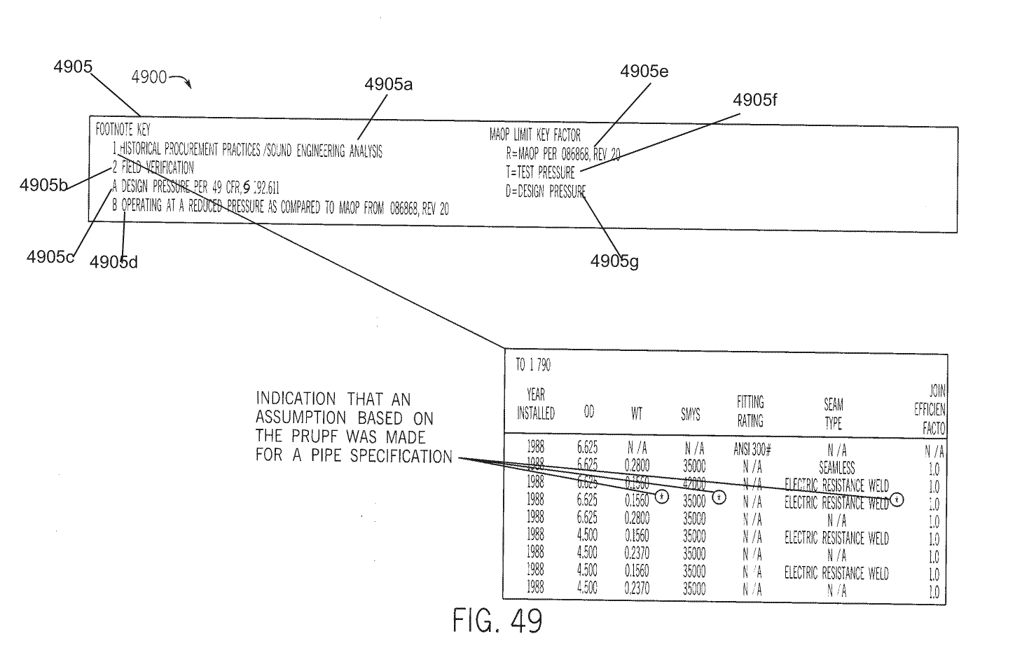

FIG. 48 is a spreadsheet diagram 4800 showing another view of the MAOP per test for the MAOP report calculations according to one embodiment of the invention. FIG. 48 provides a more detailed view than the high-level perspective presented in FIG. 47. However, in FIG. 48, examples of values comprising the STPR supported MAOP are shown (4805). Practitioners will appreciate that a report may naturally include a greater or lesser degree of detail without departing from the scope of the invention.

FIG. 49 is a spreadsheet diagram 4900 showing the assumptions for the MAOP report footnote guide according to one embodiment of the invention. In one embodiment, the MAOP report includes an indicator to denote that an assumption based on the PRUPF was made for a pipe specification (as shown in this example as “1” being printed in the columns adjacent to the displayed values, which according to the footnote Key 4905, denotes historical procurement practices/sound engineering analysis 4905a). As shown, other footnote keys include field verification 4905b, design pressure per 49 CFR. 192.611 4905c, and operating at reduced pressure as compared to MAOP from 806868, rev 20 (4905d). The footnote key 4905 can also include a MAOP limit key factors 4905e, 4905f, 4905g. Practitioners will appreciate that a report may naturally include a greater or lesser degree of detail without departing from the scope of the invention.

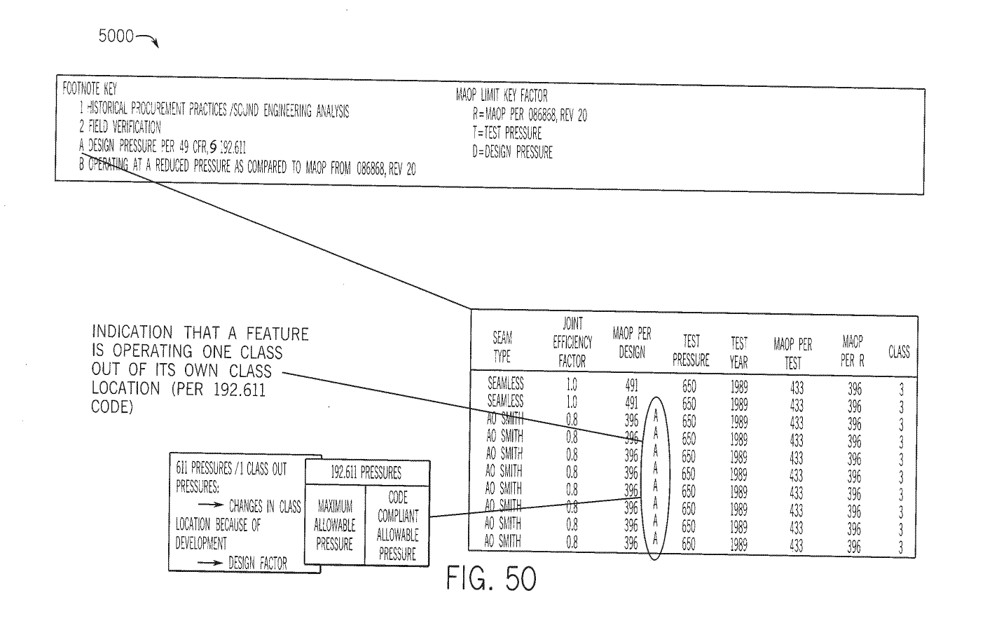

FIG. 50 is a spreadsheet diagram 5000 showing the 611 calculations for the MAOP report footnote guide according to one embodiment of the invention. Practitioners will appreciate that a report may naturally include a greater or lesser degree of detail without departing from the scope of the invention.

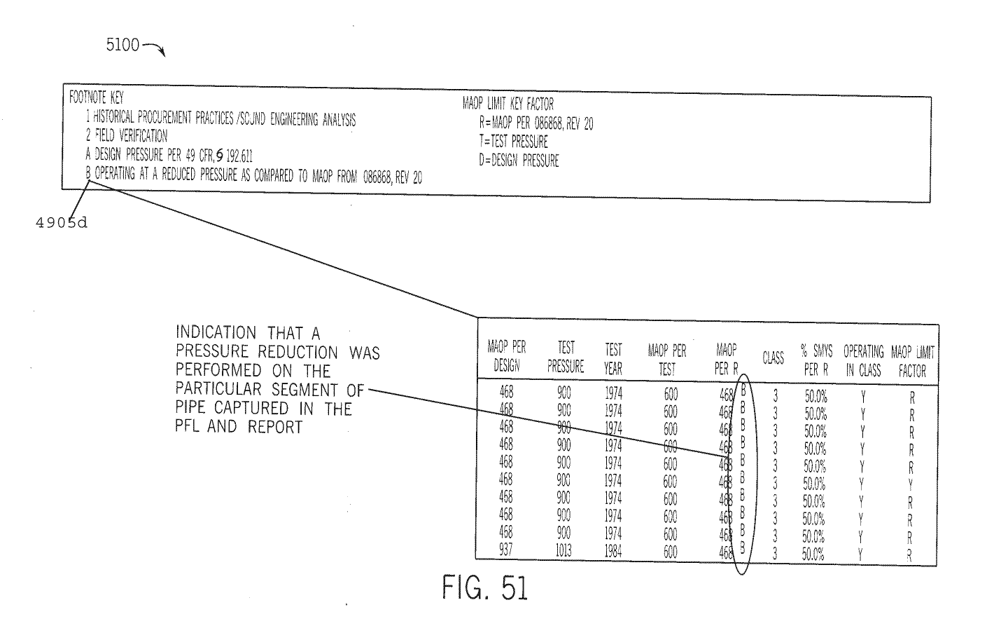

FIG. 51 is a spreadsheet diagram 5100 showing the footnote guide for the MAOP report according to one embodiment of the invention. In accordance with this embodiment, an indication that a pressure reduction was performed on a particular segment of pipe is captured in the PFL and report. In this example, the footnote key 4905 defines “B” as indicative of such a reduction in operating pressure (4905d). Practitioners will appreciate that a report may naturally include a greater or lesser degree of detail without departing from the scope of the invention.

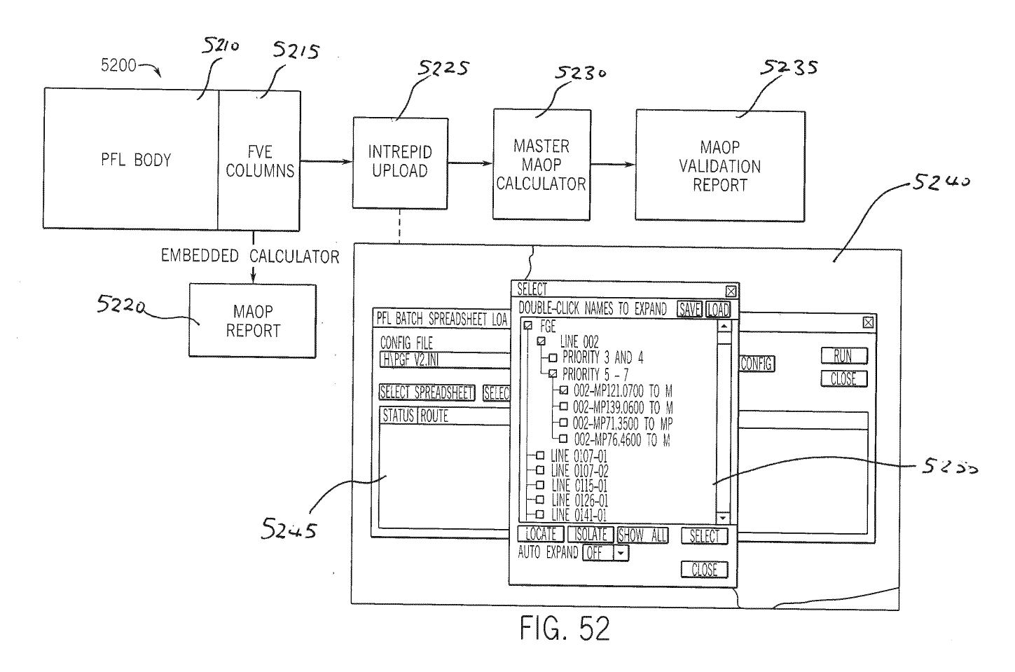

FIG. 52 is a flowchart 5200 showing the MAOP report upload and centralized calculator for Intrepid™ according to one embodiment of the invention. As shown, in some embodiments, the flowchart can include a PFL body 5210 and FVE columns 5215 coupled to a MAOP report block 5220. In some embodiments, blocks 5210, 5215 can proceed to Intrepid™ upload function 5225, master MAOP calculator 5230 and a MAOP validation report 5235. Moreover, as shown, in some embodiments, the upload 5225 can include data including spreadsheets 5245, 5250.

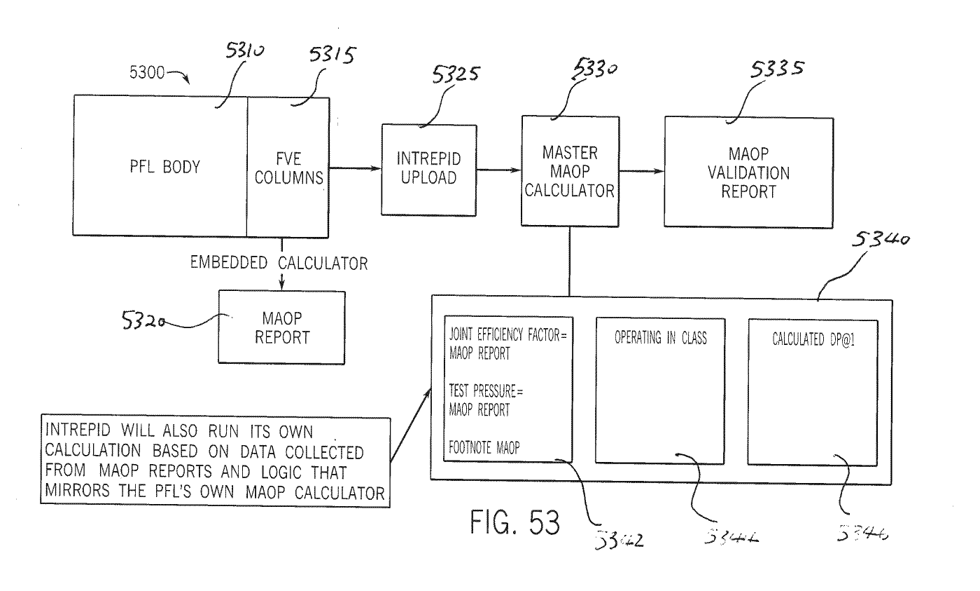

FIG. 53 is a flowchart 5300 showing the centralized calculator for Intrepid™ according to one embodiment of the invention. As shown, in one embodiment, Intrepid™ may also run its own calculation based on data collected from MAOP reports and logic that mirrors the MAOP calculator of the PFL. As shown, in some embodiments, the flowchart can include a PFL body 5310 and FVE columns 5315 coupled to a MAOP report block 5320. In some embodiments, blocks 5310, 5315 can proceed to Intrepid™ upload function 5325, master MAOP calculator 5330 and a MAOP validation report 5335. Further, in some embodiments, other calculations 5340 can run and coupled to the master MAOP calculator 5330 and can include various data including 5343, 5344 and 5346 shown in FIG. 53.

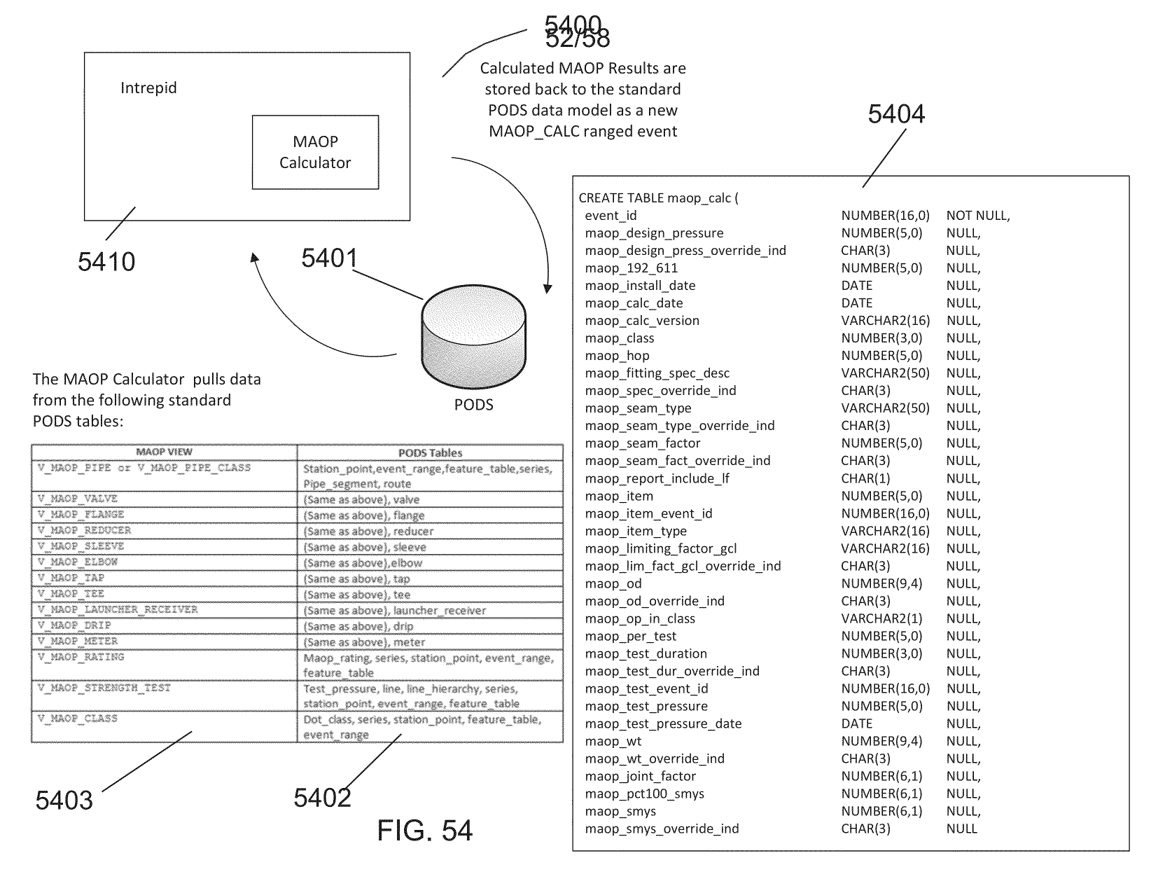

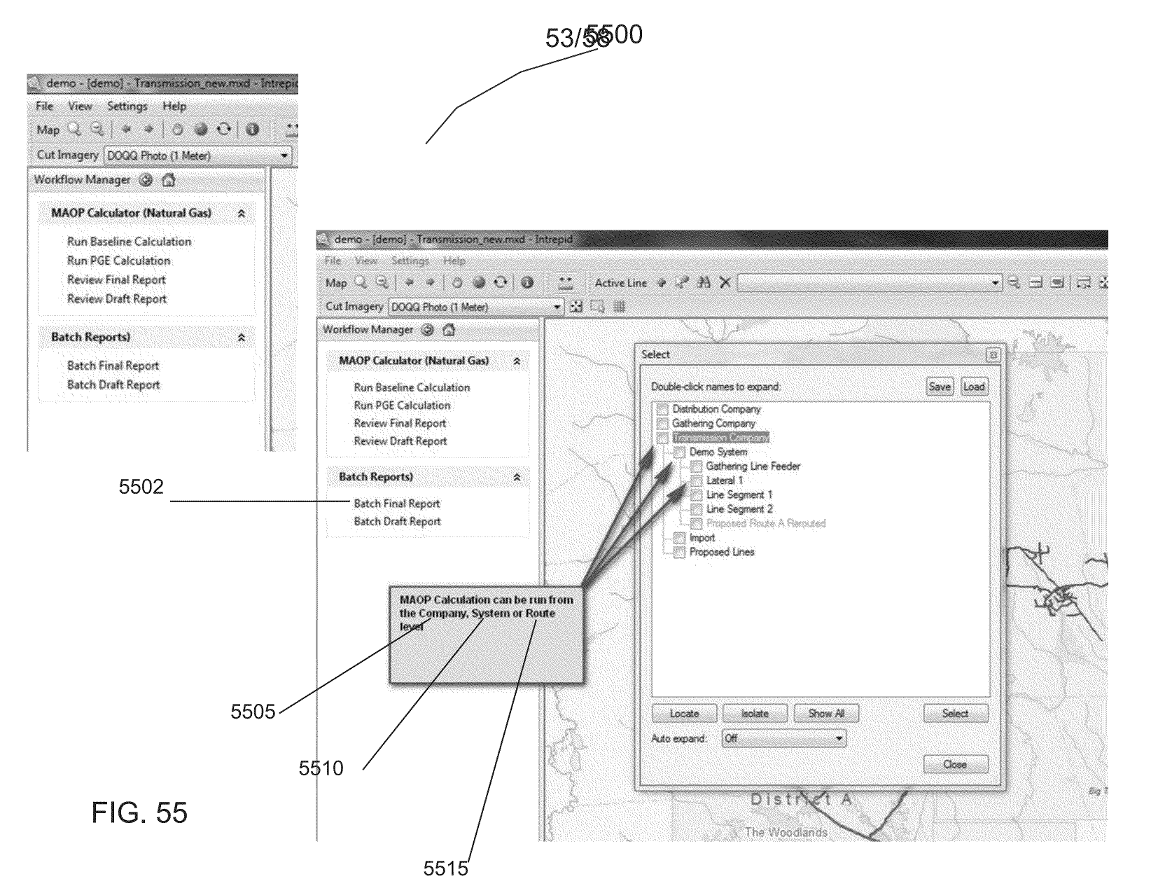

Some embodiments of the invention can include at least one system 5400 for exchanging data with industry standard data architectures, including, but not limited to PODS 5401. For example, in some embodiments, one or more the methods described by flow charts 100, 200, 300, 400, 500, 600, 700, 800, 900, 1000, 1100, 1200, 1300, 1500, 1600, 1650, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000, or blocks 4100, can process data from physical storage locations of the pipeline data including PODS. FIG. 54 depicts a system architecture 5400 and MAOP report methods including batch execution across all the pipeline segments in the PODS database 5401 in accordance with some embodiments of the invention. For example, as depicted in FIG. 54, in some embodiments, the system 5400 including Intrepid™ software 5410, can pull data from PDS data tables 5402, create a MAOP view 5403, and a MAOP calculator table 5404. Further, in some embodiments, one or more the MAOP report methods can include a software module and has the ability to execute the methods in batch across all the pipeline segments in the PODS database. Moreover, in some embodiments, the methods (for example, one or more of the methods described in flow charts 100, 200, 300, 400, 500, 600, 700, 800, 900, 1000, 1100, 1200, 1300, 1500, 1600, 1650, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000) can be run where any one method or any one item of data (for instance, any one variable from PODS) can be processed by the methods across an entire pipeline system using batch processing as described assumptions and reprocess the entire pipeline system in batch. For example, FIG. 55 shows one example of a software front-end interface 5500 for selecting MAOP reports, including batch processing 5502 of MAOP reports. As shown, in some embodiments, the methods as described and depicted in FIGS. 1-59 can include selection of an MAOP report to be run at the company level 5505, system level 5510, or route level 5515.

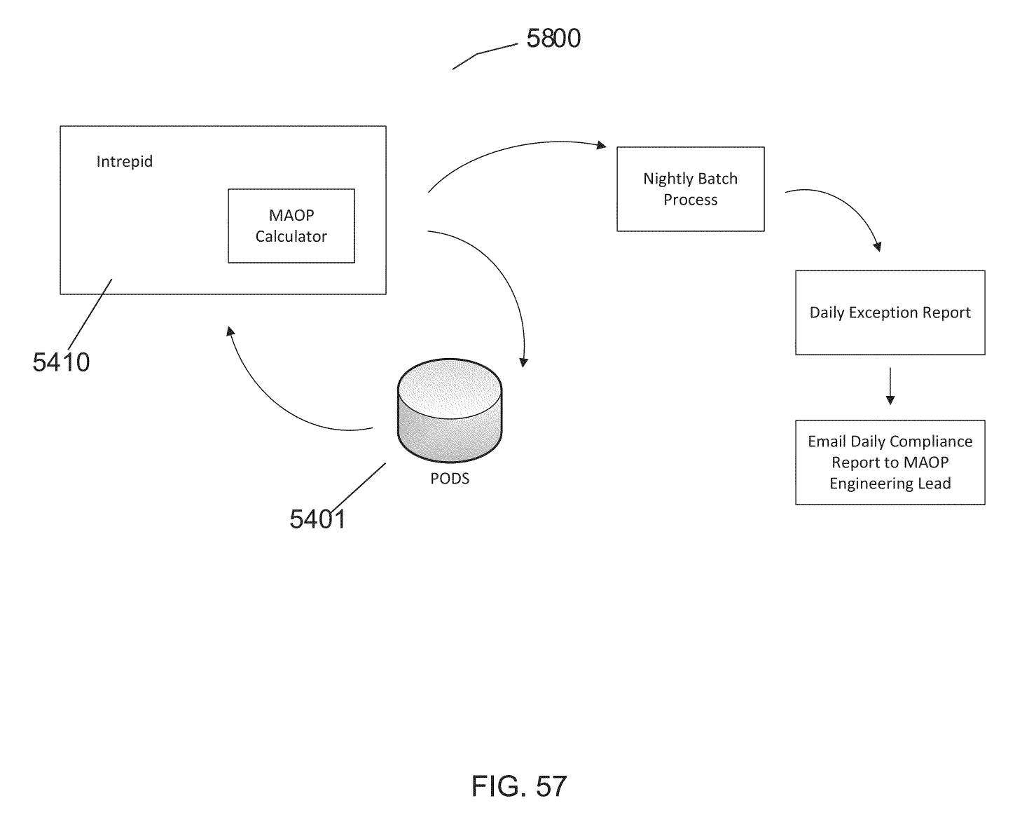

Some embodiments can include baseline monitoring. For example, in some embodiments, coupled with batch processing as described earlier, one or more of the methods as described can monitor the entire pipeline database (including for example, PODS databases 5401) for compliance with the MAOP calculations. See for example FIG. 56 showing a pipeline route 5600 with associated pipeline segments 5608 and associated data tables 5605, and FIG. 57 illustrates methods for MAOP calculations including batch processing of compliance reports in accordance with some embodiments of the invention. In this example, should any updates be made to the pipeline data 5605 that would result in an out of operating pressure compliance for any pipeline fitting or pipe segments 5608, the system 5400 (including for example, Intrepid™ software 5410 as shown) can detect this situation and report on any non-compliant pipe segment or fitting via exception report. In some embodiments, pipeline data can be pulled from any one of data tables 5605a, 5605b, 5605c, 5605d and if there is an out of operating pressure compliance for any pipeline fitting (for example elbow 5609) or pipe segments 5608, the system 5400 (including for example, Intrepid™ software 5410 as shown) can detect this situation, and report on any non-compliant pipe segment or fitting via exception report.

Some embodiments include methods for modeling of equivalent pipe events. As part of the MAOP report methods as described, historic pipeline fittings 5609 can be modeled in substantially the same way as pipe segments 5608 using the Barlows formula. In some embodiments, as depicted in FIG. 56, it can be possible to view and edit attributes for fittings 5609, and include the underlying pipe event as one object. This enables operational logic that defines pipe segments 5608 without any gaps or overlaps. As such, in some embodiments, the equivalent pipe event for the fittings 5609 is the place holder for the gap between adjacent pipe segment 5608 events.

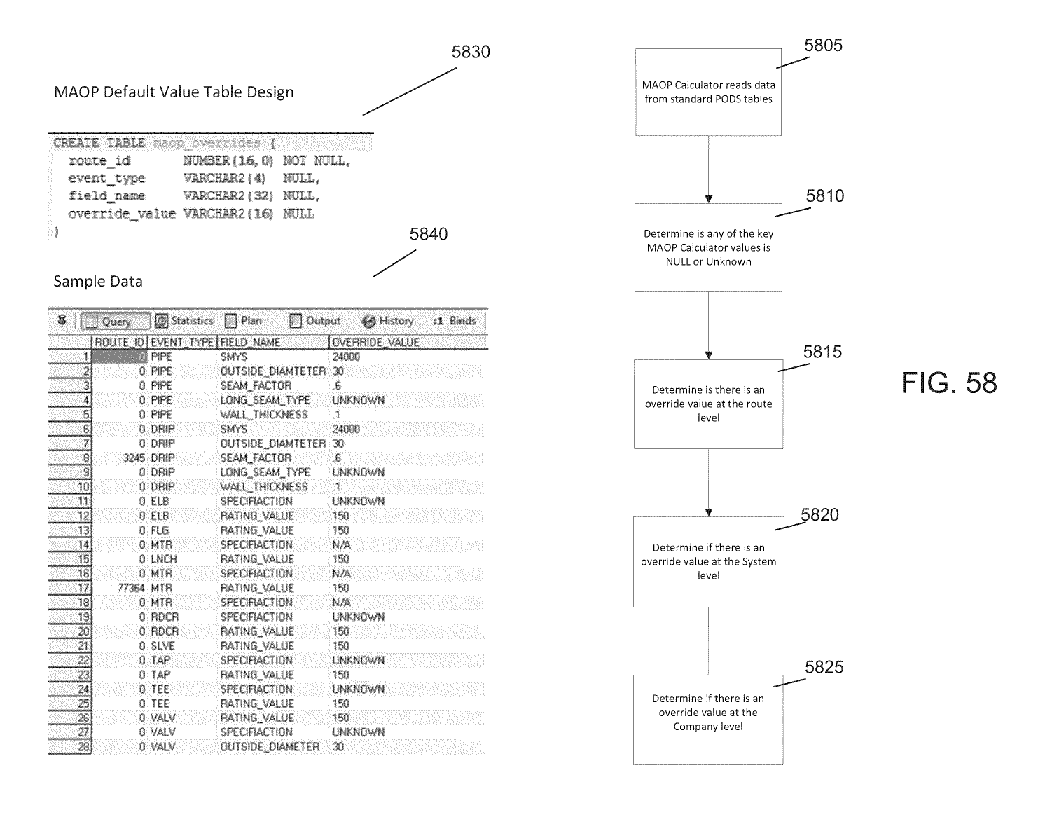

In some embodiments, one or more pipeline databases being maintained by an operator may be missing values critical to a MAOP calculation. In some cases these values are unknown, and in other cases the pipeline engineers can make determinations of key values based on past operating and design standards used at the time of the pipelines installation. In some embodiments, to keep the integrity of the pipeline data it is critical that these default values not be stored in the database where the actual confirmed pipeline data resides. The other critical component to this functionality is that we must always maintain the values that are tied to the historical pipeline documentation. In some embodiments, the Intrepid™ software 5410 allows the operator to setup an override or default value table that the calculator interrogates when it finds missing values critical to the calculation (for example, see MAOP default value table 5830 and sample data 5840 in FIG. 58). In some embodiments, these default or override values can be configured at the route, system or company level (shown as 5515, 5510, 5505 in FIG. 55). In some embodiments, if the calculator cannot find an override value at the route level it the checks the system, and if nothing is found there will default to the system 5510 or company 5505. In some embodiments, if any value is overridden, it is flagged and stored with the calculation results. In some embodiments, this allows a footnote to be displayed on the MAOP validation report indicating when a value has been updated by the default value method. For example, as shown in FIG. 58, the method can include MAOP calculator reads data from standard PODS tables 5805. In some embodiments, the method can include determine is there any of the key MAOP calculator values are null or unknown 5810, and determine is there an override value at the route level 5815. In some embodiments, the method can include determine if there is an override value at the system level 5820, and then determine if there is an override value at the company level 5825.

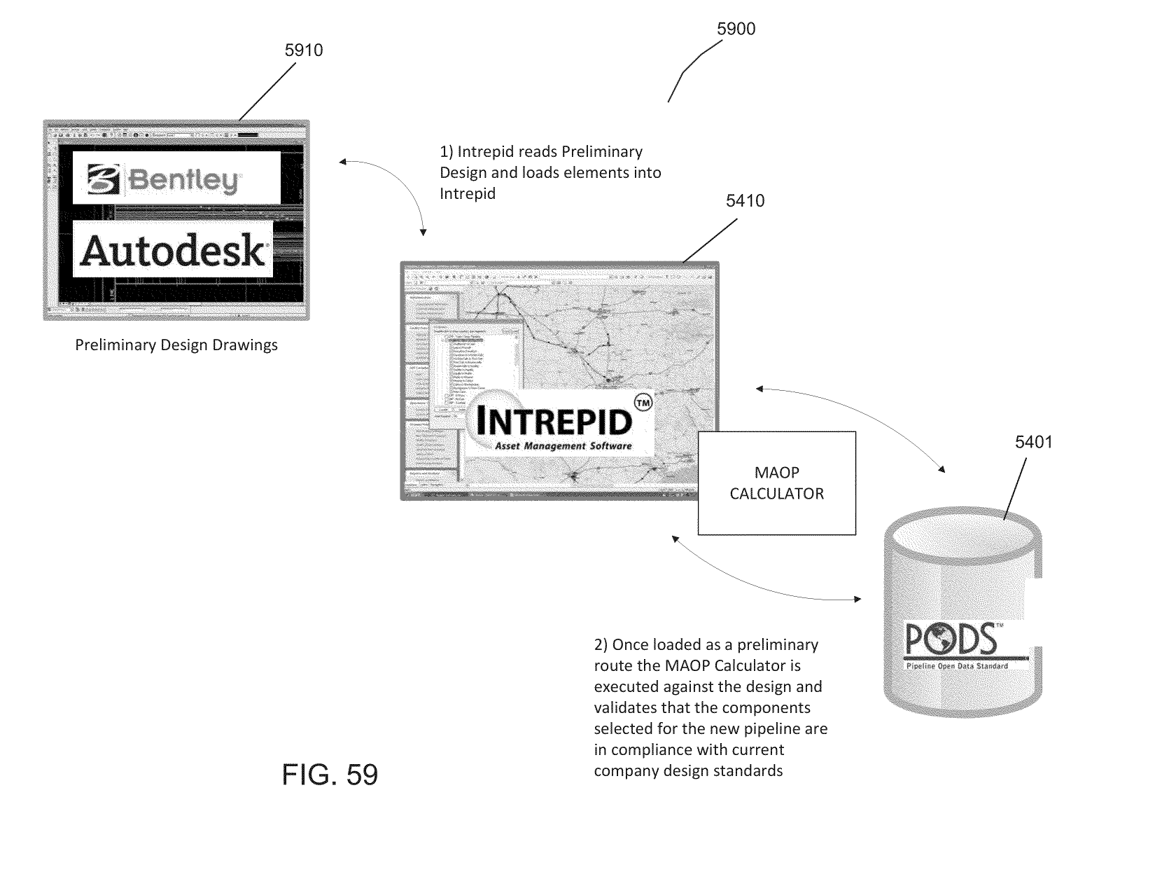

Some embodiments include methods to input one or more pipeline designs using a computer aided design software package 5910. For example, as depicted in FIG. 59, in some embodiments, preliminary pipeline designs can be uploaded into the Intrepid™ system 5410 from a Bentley® CAD/CAM software platform such as Bentley Microstation®. Bentley® and Bentley MicroStation® are registered trademarks of Bentley Systems Inc, or Bentley Software Inc. In other embodiments, preliminary pipeline designs can be uploaded into the Intrepid™ system 5410 from an Autodesk, Inc AutoCAD® CAD/CAM software product. AutoCAD® is a registered trademarks of Autodesk, Inc. As depicted, in some embodiments, MAOP calculations can be executed against the design data retrieved from a computer aided design software package 5910 to confirm that the pipeline is being built to operate within the expected operating pressure of the proposed line.

Various examples have been presented showing an exemplary MAOP report in accordance with an embodiment of the disclosed system and method. However, the specific format of the report, as well as the data types contained therein may be modified without departing from the scope of the invention. Moreover, the MAOP does not require all of the data shown in the figures to be present, nor do the examples show every possible data type that may comprise a MAOP report.

In one embodiment, the system and method includes an interface that allows a user to configure the MAOP report in accordance with preferences and or specific needs. Commercial report writing products exist that may be implemented into the system and method. One such product is SAP® Crystal Reports produced by SAP AG for example. SAP® Crystal Reports are the trademarks or registered trademarks of SAP AG in Germany and in several other countries

However, those of ordinary skill in the art will appreciate that any commercial or proprietary reporting tools may be implemented.

In some embodiments, the MAOP report may take various forms including, for example, paper reports and electronic reports. In some embodiments, paper reports may be printed from a personal computer or mainframe computing system. In some embodiments, electronic reports may be delivered by way of a user interface on a computing device, sent as an attachment to an email message, accessed via a smartphone device, viewed on a webpage, and the like. Moreover, in some embodiments, the user may be provided interface elements to allow for the filtering and ordering of data within the report.

In one embodiment, the report may be configured such that automated systems are invoked in response to defined values being present in the report. For example, a value falling outside of a defined threshold may automatically cause the report to be emailed to a mailing list of engineers and managers. In still another embodiment, certain values in the report may trigger automated tasks relating to the pipeline infrastructure. For example, a value that is outside of a maximum pressure value may cause a valve (for example, valve 850a, 850b) to divert pressure to a second pipeline or reduce the pressure flowing into an affected pipeline.

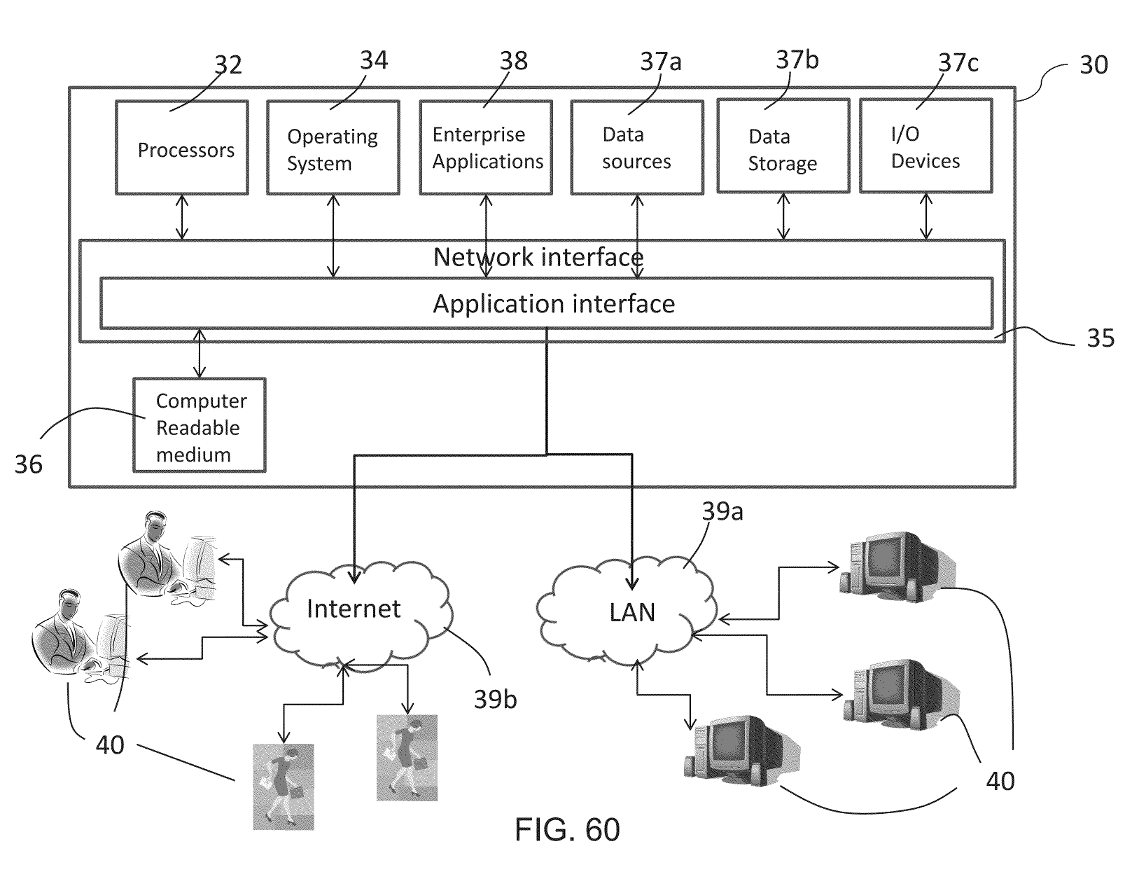

FIG. 60 shows one example of a system architecture 30 that, in some embodiments, can be used to implement at least one of the methods or reports described earlier and illustrated in FIGS. 1-59. As shown, the system 30 can include at least one computing device, including at least one or more processors 32. Some processors 32 may include processors 32 residing in one or more server platforms. The system architecture 30 may include a network and application interface 35 coupled to a plurality of processors 32 running at least one operating system 34, coupled to at least one data storage device 37b, a plurality of data sources 37a, and at least one input/output device 37c. Some embodiments include at least one computer readable medium 36. For example, in some embodiments, the invention can also be embodied as computer readable code on a computer readable medium 36. The computer readable medium 36 may be any data storage device that can store data, which can thereafter be read by a computer system. Examples of the computer readable medium 36 can include hard drives, network attached storage (NAS), read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor. The computer readable medium 36 can also be distributed over a network so that the computer readable code may be stored and executed in a distributed fashion. For example, in some embodiments, one or more components of the system architecture 30 can be tethered to send and/or receive data through a local area network (LAN) 39a. In some further embodiments, one or more components of the system architecture 30 can be tethered to send or receive data through an internet 39b. In some embodiments, at least one software module (including for instance, enterprise applications 38), and one or more components of the system architecture 30 may be configured to be coupled for communication over a network 39a, 39b. In some embodiments, one or more components of the network 39a, 39b can include one or more resources for data storage, including any other form of computer readable media beyond the media 36 for storing information and including any form of computer readable media for communicating information from one electronic device to another electronic device.

In some embodiments, the system architecture 30 as described can enable one or more users 40 to receive, analyze, input, modify, create and send data to the system architecture 30, including to and from one or more enterprise applications 38 running on the system architecture 30, and/or to a network 39a, 39b. In some embodiments, the network 39a, 39b may include wide area networks (WAN's), direct connections, such as through a universal serial bus (USB) port, other forms of computer-readable media, or any combination thereof. Also, various other forms of computer-readable media 36 may transmit or carry instructions to a computer, including a router, private or public network, or other transmission device or channel, both wired and wireless. In some embodiments, one or more components of the network 39a, 39b can include a number of client devices which may be personal computers, digital assistants, personal digital assistants, cellular phones, mobile phones, smart phones, pagers, digital tablets, laptop computers, Internet appliances, and other processor-based devices. In general, a client device can be any type of external or internal devices such as a mouse, a CD-ROM, DVD, a keyboard, a display, or other input or output devices.

While one embodiment can be implemented in fully functioning computers and computer systems as described with respect to FIG. 60 (depicted as system architecture 30), various embodiments are capable of being distributed as a computing product in a variety of forms and are capable of being applied regardless of the particular type of machine or computer-readable media used to actually effect the distribution. For example, in some embodiments, at least some aspects disclosed can be embodied, at least in part, in software. That is, the techniques may be carried out in a computer system 30 or other data processing system in response to its processors 32 (such as a microprocessor) executing sequences of instructions contained in a memory, such as ROM, volatile RAM, non-volatile memory, cache or a remote storage device 37a, 37b, 36. Further, in some embodiments, the above-described methods and reports implemented with system architecture 30 can store analytical models and other data on computer-readable storage media 36, 37a, 37b. With the above embodiments in mind, it should be understood that the invention can employ various computer-implemented operations involving data stored in computer systems (such as for example, system 30). These operations are those requiring physical manipulation of physical quantities. Usually, though not necessarily, these quantities take the form of electrical or magnetic signals capable of being stored, transferred, combined, compared and otherwise manipulated. Moreover, in some embodiments, the instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

Any of the operations described herein that form part of the invention are useful machine operations. The processes and method steps performed within the system architecture 30 cannot be performed in the human mind or derived by a human using pen and paper, but require machine operations to process input data to useful output data. For example, the processes and method steps performed with the system architecture 30 can include a computer-implemented method comprising steps performed by at least one processor 32. The embodiments of the present invention can also be defined as a machine that transforms data from one state to another state. The data may represent an article, that can be represented as an electronic signal and electronically manipulate data. The transformed data can, in some cases, be visually depicted on a display, representing the physical object that results from the transformation of data. The transformed data can be saved to storage 37a, 37b, 36, or in particular formats that enable the construction or depiction of a physical and tangible object. In some embodiments, the manipulation can be performed by a processor 32. In such an example, the processor 32 thus transforms the data from one thing to another. Still further, the methods can be processed by one or more machines or processors 32 that can be connected over a network 39a, 39b. Each machine can transform data from one state or thing to another, and can also process data, save data to storage, transmit data over a network, display the result, or communicate the result to another machine. Computer-readable storage media 36, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

The invention also relates to a device or an apparatus for performing these operations. The apparatus may be specially constructed for the required purpose, such as a special purpose computer system 30. When defined as a special purpose computer system 30, the computer system 30 can also perform other processing, program execution or routines that are not part of the special purpose, while still being capable of operating for the special purpose. Alternatively, the operations may be processed by a general purpose computer selectively activated or configured by one or more computer programs stored in the computer memory, cache, or obtained over a network. When data is obtained over a network the data may be processed by other computers on the network, e.g. a cloud of computing resources.

Although method operations may be described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way.

Some embodiments can include the methods as described as follows:

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the invention.

1. A pipeline analysis system comprising:
a processor;
a first non-transitory computer-readable storage medium for tangibly storing thereon program logic for execution by the processor, the program logic comprising:
logic executed by the processor for receiving and tangibly storing on a second non-transitory computer-readable storage medium a dataset including pipeline component data corresponding to an existing or planned physical pipeline;
logic executed by the processor for analyzing the dataset to determine compliance with desired maximum allowable pipeline operating pressures;
logic executed by the processor for enabling revision of the pipeline component data to specify pipeline components that are in compliance with desired maximum allowable pipeline operating pressures; and
logic executed by the processor for providing an exception report listing non-compliant pipeline components.

2. The pipeline analysis system of claim 1, wherein the pipeline component data includes data corresponding to pipe segments, pipe fittings and pipe valves.

3. The pipeline analysis system of claim 1, wherein the dataset is analyzed using batch processing techniques.

4. The pipeline analysis system of claim 3, wherein the dataset contains pipeline component data for an entire pipeline.

5. The pipeline analysis system of claim 1, wherein the dataset is analyzed at least in part by comparing the pipeline component data to an industry standard pipeline database stored on a third non-transitory computer-readable medium.

6. A pipeline analysis system comprising:
a processor;
a first non-transitory computer-readable storage medium for tangibly storing thereon program logic for execution by the processor, the program logic comprising:
logic executed by the processor for receiving and tangibly storing on a second non-transitory computer-readable storage medium a dataset including pipeline component data corresponding to an existing or planned physical pipeline;
logic executed by the processor for analyzing the dataset to determine compliance with desired maximum allowable pipeline operating pressures;
logic executed by the processor for enabling revision of the pipeline component data to specify at least one pipeline component having at least one different characteristic than was originally specified in the dataset; and
logic executed by the processor for analyzing the revised dataset to determine the maximum allowable pipeline operating pressure for the existing or planned physical pipeline.

7. The pipeline analysis system of claim 6, further including logic executed by the processor for enabling a maximum allowable pipeline operating pressure and providing an exception report listing non-compliant pipeline components.

8. The pipeline analysis system of claim 6, wherein the pipeline component data includes data corresponding to pipe segments, pipe fittings and pipe valves.

9. The pipeline analysis system of claim 6, wherein the dataset is analyzed using batch processing techniques.

10. The pipeline analysis system of claim 8, wherein the dataset contains pipeline component data for an entire pipeline.

11. The pipeline analysis system of claim 6, wherein the dataset is analyzed at least in part by comparing the pipeline component data to an industry standard pipeline database stored on a third non-transitory computer-readable medium.
